(19) United States
(12) Patent Application Publication
(10) Pub. No.: US 2026/0312722 A1
(43) Pub. Date: Oct. 8, 2026

(54) RECOVERY MECHANISM FOR A SEQUENCE MISDETECTION

(71) Applicant: QUALCOMM Incorporated, San Diego, CA (US)

(72) Inventors: Sarath PINAYOUR CHANDRASEKARAN, Hyderabad (IN); Satish KUMAR, Hyderabad (IN); Anshuman MISHRA, Hyderabad (IN)

(21) Appl. No.: 19/098,026

(22) Filed: Apr. 2, 2025

(51) Int. Cl. H04L 1/00; H04L 25/02

(52) U.S. Cl. CPC H04L 1/0054; H04L 25/0202

(57) ABSTRACT

Various aspects of the present disclosure generally relate to wireless communication. Some aspects relate generally to enabling a wireless communication device to identify and correct sequence misdetections. Some aspects more specifically relate to a first wireless communication device identifying or detecting a misdetection event for a first sequence (e.g., a detected sequence) based at least in part on one or more communications received from a second wireless communication device. The first wireless communication device may transmit a second sequence (e.g., a corrected sequence) based at least in part on the misdetection event.

### FIELD OF THE DISCLOSURE

Aspects of the present disclosure generally relate to wireless communication and specifically relate to techniques, apparatuses, and methods associated with a recovery mechanism for a sequence misdetection.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

In some examples, wireless communication devices may communicate using cyclic-shift-based communications. For example, a first wireless communication device may transmit a sequence that is to be used to identify the first wireless communication device. A sequence may be a cyclic-shifted version of a root sequence, such as a Zadoff-Chu sequence or another type of sequence. As an example, the first wireless communication device may be an ambient Internet-of-things (A-IoT) device, which may be a low-cost or low-complexity device. The A-IoT device may transmit a cyclic-shift-based communication to enable another wireless communication device (e.g., a reader device) to identify the A-IoT device. As an example, the A-IoT device may transmit a sequence to enable the reader device to identify the A-IoT device during a random access procedure, an inventory procedure, a feedback procedure, or another type of procedure.

In some cases, transmissions from the A-IoT device may experience sampling frequency offset (SFO) due to the low-cost or low-complexity design of the A-IoT device (e.g., the A-IoT device may include less precise components, such as oscillators that may not maintain a stable frequency over time). The SFO may introduce frequency errors that can lead to time errors in the transmissions by the A-IoT device. The time errors may result in non-orthogonality between sequences detected by the reader device. For example, the time errors can cause a detected peak of a transmitted sequence to shift from an original time window to an adjacent time window (e.g., where the adjacent time window is associated with a different sequence). This may result in a misdetection of the sequence by the reader device (e.g., the reader device may detect the different sequence rather than the sequence transmitted by the A-IoT device). The sequence misdetection may result in a misidentification of the A-IoT device, or a failure of a cyclic-shift-based communication (such as a random access procedure or an inventory procedure).

Various aspects relate generally to enabling a wireless communication device to identify and correct sequence misdetections. Some aspects more specifically relate to a first wireless communication device (e.g., a reader device) identifying or detecting a misdetection event for a first sequence (e.g., a detected sequence) based at least in part on one or more communications received from a second wireless communication device (e.g., an A-IoT device). The first wireless communication device may transmit a second sequence (e.g., a corrected sequence) based at least in part on the misdetection event.

In some aspects, the one or more communications may include a sequence communication (e.g., that indicates a first sequence) and a payload communication (e.g., that includes a payload). The second wireless communication device may generate at least a portion of the payload (e.g., a channel estimate reference signal or data) using the index of the first sequence (e.g., using the index as an input). The first wireless communication device may detect a sequence based on the sequence communication and attempt to decode the payload communication using an index of the detected sequence. The misdetection event may include the decoding of the payload communication using the index of the detected sequence. In such examples, the first wireless communication device may attempt to decode the payload communication using an index of one or more sequences that are adjacent to the detected sequence. If the first wireless communication device successfully decodes the payload using a given index (e.g., of an adjacent sequence), then the first wireless communication device may transmit an indication of the adjacent sequence (e.g., the second sequence described above).

In some aspects, the first wireless communication device may detect or identify the misdetection event based at least in part on a detected peak location (e.g., in the time domain) of the sequence communication. For example, a first sequence may be associated with a sequence window in the time domain. The misdetection event may include the detected peak location being within a time window that is included in the sequence window. The time window may include a quantity of time domain samples from a start or end of the sequence window. In such examples, the first wireless communication device may transmit an indication of the first sequence and a second sequence, where the second sequence corresponds to the time window in which the detected peak location occurs.

Particular aspects of the subject matter described in this disclosure can be implemented to realize one or more of the following potential advantages. By the first wireless communication device detecting the misdetection event, the first wireless communication device can transmit an indication (or index) of a second sequence (e.g., that is different than a first sequence detected by the first wireless communication device) that has a higher likelihood of being the sequence originally transmitted by the second wireless communication device. By the first wireless communication device transmitting the indication of the second sequence, a likelihood of success of a cyclic-shift-based (or sequence-based) procedure (e.g., that includes the second wireless communication device transmitting a sequence) may be improved. This enables the first wireless communication device and the second wireless communication device to conserve network resources, energy resources, or other resources that would have otherwise been associated with re-attempting the cyclic-shift-based (or sequence-based) procedure due to a sequence misdetection by the first wireless communication device. As an example, this may increase the likelihood of success of a random access procedure or inventory procedure for an A-IoT device, enabling the A-IoT device (e.g., which may have limited energy resources) to conserve energy resources that would have otherwise been associated with re-attempting the random access procedure or inventory procedure.

In some aspects, by the first wireless communication device attempting to decode a payload using one or more indices of one or more adjacent sequences to a detected sequence, the likelihood of the first wireless communication device successfully decoding the payload (e.g., without additional communication exchanges with the second wireless communication device) may be improved. For example, by the second wireless communication device generating at least a portion of the payload using an index of a transmitted sequence, the second wireless communication device may create an association between the sequence communication and the payload communication. The first wireless communication device can use this association to autonomously detect and correct sequence misdetections, thereby enhancing communication reliability and conserving network and processing resources by reducing the need for additional communications to correct the sequence misdetection.

The systems, methods, and devices of this disclosure each have several innovative aspects, no single one of which is solely responsible for the desirable attributes disclosed herein.

In some aspects, an apparatus for wireless communication at a first wireless communication device includes one or more memories; and one or more processors coupled to the one or more memories, the one or more processors individually or collectively configured to: receive, from a second wireless communication device, one or more first communications that include a payload communication; detect a first sequence indicated by the one or more first communications; perform a decoding operation for the payload communication, the decoding operation indicating a misdetection event associated with the first sequence; and transmit a second communication that indicates a second sequence based at least in part on the misdetection event, the second sequence being based at least in part on the first sequence, and the second sequence being associated with the payload communication.

In some aspects, an apparatus for wireless communication at a first wireless communication device includes one or more memories; and one or more processors coupled to the one or more memories, the one or more processors individually or collectively configured to: receive an indication of one or more sequence indices associated with one or more sequences; transmit a first communication that indicates a sequence from the one or more sequences; and transmit a second communication that includes one or more portions that are based at least in part on an index of the sequence from the one or more sequence indices.

In some aspects, an apparatus for wireless communication at a first wireless communication device includes one or more memories; and one or more processors coupled to the one or more memories, the one or more processors individually or collectively configured to: receive, from a second wireless communication device, a first communication; detect a first sequence indicated by the first communication, the first sequence being based at least in part on a detected peak location of the first communication in a time domain, and the detected peak location indicating a misdetection event associated with the first sequence; and transmit a second communication that indicates a second sequence based at least in part on the misdetection event.

In some aspects, a method of wireless communication performed by a first wireless communication device includes receiving, from a second wireless communication device, one or more first communications that include a payload communication; detecting a first sequence indicated by the one or more first communications; performing a decoding operation for the payload communication, the decoding operation indicating a misdetection event associated with the first sequence; and transmitting a second communication that indicates a second sequence based at least in part on the misdetection event, the second sequence being based at least in part on the first sequence, and the second sequence being associated with the payload communication.

In some aspects, a method of wireless communication performed by a first wireless communication device includes receiving an indication of one or more sequence indices associated with one or more sequences; transmitting a first communication that indicates a sequence from the one or more sequences; and transmitting a second communication that includes one or more portions that are based at least in part on an index of the sequence from the one or more sequence indices.

In some aspects, a method of wireless communication performed by a first wireless communication device includes receiving, from a second wireless communication device, a first communication; detecting a first sequence indicated by the first communication, the first sequence being based at least in part on a detected peak location of the first communication in a time domain, and the detected peak location indicating a misdetection event associated with the first sequence; and transmitting a second communication that indicates a second sequence based at least in part on the misdetection event.

In some aspects, a non-transitory computer-readable medium storing a set of instructions for wireless communication includes one or more instructions that, when executed by one or more processors of a first wireless communication device, cause the first wireless communication device to: receive, from a second wireless communication device, one or more first communications that include a payload communication; detect a first sequence indicated by the one or more first communications; perform a decoding operation for the payload communication, the decoding operation indicating a misdetection event associated with the first sequence; and transmit a second communication that indicates a second sequence based at least in part on the misdetection event, the second sequence being based at least in part on the first sequence, and the second sequence being associated with the payload communication.

In some aspects, a non-transitory computer-readable medium storing a set of instructions for wireless communication includes one or more instructions that, when executed by one or more processors of a first wireless communication device, cause the first wireless communication device to: receive an indication of one or more sequence indices associated with one or more sequences; transmit a first communication that indicates a sequence from the one or more sequences; and transmit a second communication that includes one or more portions that are based at least in part on an index of the sequence from the one or more sequence indices.

In some aspects, a non-transitory computer-readable medium storing a set of instructions for wireless communication includes one or more instructions that, when executed by one or more processors of a first wireless communication device, cause the first wireless communication device to: receive, from a second wireless communication device, a first communication; detect a first sequence indicated by the first communication, the first sequence being based at least in part on a detected peak location of the first communication in a time domain, and the detected peak location indicating a misdetection event associated with the first sequence; and transmit a second communication that indicates a second sequence based at least in part on the misdetection event.

In some aspects, an apparatus for wireless communication includes means for receiving, from a second wireless communication device, one or more first communications that include a payload communication; means for detecting a first sequence indicated by the one or more first communications; means for performing a decoding operation for the payload communication, the decoding operation indicating a misdetection event associated with the first sequence; and means for transmitting a second communication that indicates a second sequence based at least in part on the misdetection event, the second sequence being based at least in part on the first sequence, and the second sequence being associated with the payload communication.

In some aspects, an apparatus for wireless communication includes means for receiving an indication of one or more sequence indices associated with one or more sequences; means for transmitting a first communication that indicates a sequence from the one or more sequences; and means for transmitting a second communication that includes one or more portions that are based at least in part on an index of the sequence from the one or more sequence indices.

In some aspects, an apparatus for wireless communication includes means for receiving, from a second wireless communication device, a first communication; means for detecting a first sequence indicated by the first communication, the first sequence being based at least in part on a detected peak location of the first communication in a time domain, and the detected peak location indicating a misdetection event associated with the first sequence; and means for transmitting a second communication that indicates a second sequence based at least in part on the misdetection event.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIGS. 2A-2C are diagrams illustrating examples associated with different types of ambient Internet-of-things (A-IoT) devices.

FIG. 3 is a diagram illustrating an example associated with backscatter communications.

FIG. 4 is a diagram illustrating examples of topologies for A-IoT devices, in accordance with the present disclosure.

FIG. 5 is a diagram illustrating an example associated with an access procedure for A-IoT devices.

FIG. 6 is a diagram of an example associated with a recovery mechanism for a sequence misdetection.

FIG. 7 is a diagram of an example associated with a recovery mechanism for a sequence misdetection.

FIG. 8 is a diagram of an example associated with sequence windows and sequence misdetections.

FIG. 9 is a flowchart of an example method of wireless communication.

FIG. 10 is a flowchart of an example method of wireless communication.

FIG. 11 is a flowchart of an example method of wireless communication.

FIG. 12 is a diagram of an example apparatus for wireless communication.

FIG. 13 is a diagram illustrating an example of a hardware implementation for an apparatus employing a processing system.

FIG. 14 is a diagram of an example apparatus for wireless communication.

FIG. 15 is a diagram illustrating an example of a hardware implementation for an apparatus employing a processing system.

### DETAILED DESCRIPTION

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

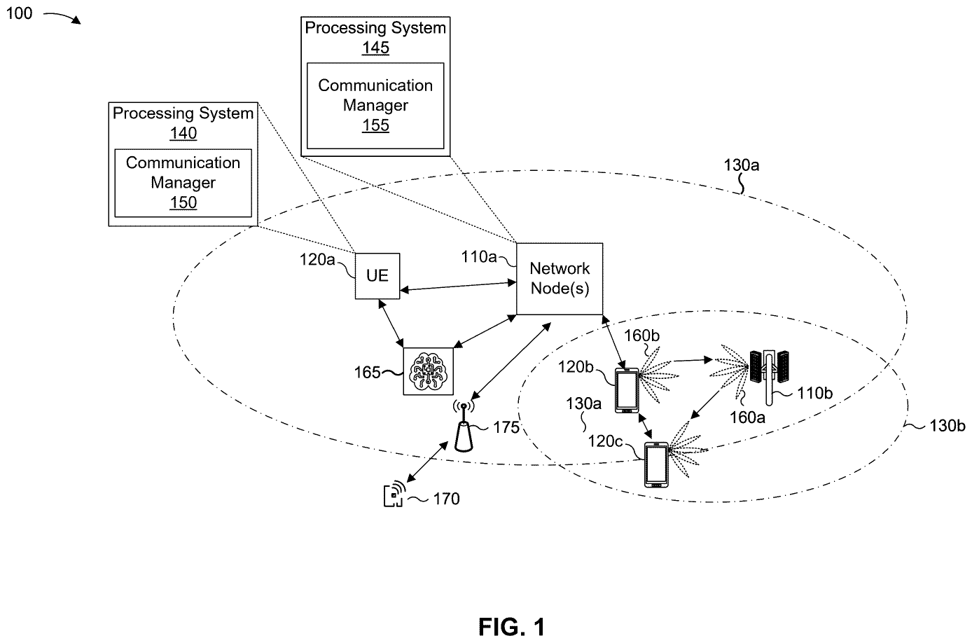

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple user equipments (UEs) 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

Some IoT devices, such as ambient IoT (A-IoT) devices 170 (sometimes referred to as ultra-light IoT devices), may be associated with a relatively simple hardware design that may be designed to use low power and be implementable at low cost. “IoT device” refers to device or object that includes one or more sensors or other components to enable data collection or exchange over via a wireless communication network. “Ambient” IoT device refers to an IoT device configured to monitor or interact with an environment in a passive, context-aware manner, using minimal user intervention while obtaining, receiving, processing, or transmitting data, among other examples. In some examples, an A-IoT device 170 may be configured to harvest energy from a carrier wave (CW), store energy from a CW, or backscatter a CW. “Harvesting” energy may refer to an A-IoT device capturing or converting energy (such as energy from a CW) into usable electrical power.

A-IoT technology may include passive IoT (such as NR passive IoT for 5G Advanced), semi-passive IoT, active IoT, or ultra-light IoT. In passive IoT, an A-IoT device 170 (such as a terminal, a tag, or a similar device) may not include a battery or other long-term energy storage, and the A-IoT device 170 may accumulate energy from radio signaling. In some examples, the A-IoT device 170 may accumulate solar or other energy to supplement accumulated energy from radio signaling.

To achieve further cost reduction and zero-power communication, backscattering communication may be implemented at a type of passive IoT device 170 referred to as an “ambient backscatter device” or a “backscatter device,” which may modulate a reflecting radio signal from an RF source to convey data. Some A-IoT device 170 may be referred to as semi-passive IoT devices. At a semi-passive IoT device, communication between a reader device 175 and the A-IoT device 170 does not need to be preceded by an energy harvesting waveform. For example, a semi-passive IoT device may include a battery or similar energy source that can power the semi-passive IoT device. Some A-IoT device 170 may be referred to as active IoT devices. An active IoT device may have a battery or similar energy source and an active radio, allowing for active transmission and reception without energy harvesting or backscattering.

A-IoT technology may be useful in connection with industrial sensors, for which battery replacement may be prohibitively difficult or undesirable (such as for safety monitoring or fault detection in smart factories, infrastructures, or environments). Additionally, features of A-IoT devices, such as low cost, small size, simple or infrequent maintenance, durability, and long lifespan, may facilitate smart logistics and warehousing (for example, in connection with automated asset management). Furthermore, A-IoT technology may be useful in connection with smart home networks for household item management, wearable devices, or similar applications.

In some examples, an A-IoT device 170 may communicate signaling with a reader device 175. As used herein, “reader” device may refer to a device that may initiate communications with the one or more A-IoT devices 170, for example, by transmitting a message (e.g., a trigger message, a paging message, an inventory trigger message, a command trigger message, or a Msg. 0 communication) to cause the A-IoT device 170 to transmit a response message or perform an action, which may be associated with one or more services of the A-IoT device 170. The reader device 175 may be a network node 110 or a UE 120. As an example, the reader device 175 may request a service from the A-IoT device 170 by transmitting a message (e.g., a trigger message, a paging message) requesting the service from the A-IoT device 170. Requesting a service from the A-IoT device may refer to requesting transmission of one or more messages from the A-IoT device 170 (e.g., sensing reports, positioning reports), requesting information stored at the A-IoT device 170 (e.g., inventory services), requesting to initiate communications with the A-IoT device 170, or requesting for the A-IoT device 170 to perform an action (e.g., a task or function, such as sensing, reading or writing data to a memory of the A-IoT device, obtaining or reporting location data, updating an inventory associated with the A-IoT device), or cause an action to be performed (e.g., internal or external to the A-IoT device), among other examples. Accordingly, the A-IoT device 170 may provide such service based on receiving the message from the reader device. As an example, the A-IoT device 170 may transmit, to the reader device 175, a cyclic-shift-based or sequence-based communication that indicates a sequence. The reader device 175 may use the sequence to identify the A-IoT device 170, as described in more detail elsewhere herein.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a wireless communication device (e.g., the UE 120 or the A-IoT device 170) may include a communication manager 150. As described in more detail elsewhere herein, the communication manager 150 may receive an indication of one or more sequence indices associated with one or more sequences; transmit a first communication that indicates a sequence from the one or more sequences; and transmit a second communication that includes one or more portions that are based at least in part on an index of the sequence from the one or more sequence indices. Additionally, or alternatively, the communication manager 150 may perform one or more other operations described herein.

In some aspects, a wireless communication device (e.g., the network node 110 or reader device 175) may include a communication manager 155. As described in more detail elsewhere herein, the communication manager 155 may receive, from a second wireless communication device, one or more first communications that include a payload communication; detect a first sequence indicated by the one or more first communications; perform a decoding operation for the payload communication, the decoding operation indicating a misdetection event associated with the first sequence; and transmit a second communication that indicates a second sequence based at least in part on the misdetection event, the second sequence being based at least in part on the first sequence, and the second sequence being associated with the payload communication. Additionally, or alternatively, the communication manager 155 may receive, from a second wireless communication device, a first communication; detect a first sequence indicated by the first communication, the first sequence being based at least in part on a detected peak location of the first communication in a time domain, and the detected peak location indicating a misdetection event associated with the first sequence; and transmit a second communication that indicates a second sequence based at least in part on the misdetection event. Additionally, or alternatively, the communication manager 155 may perform one or more other operations described herein.

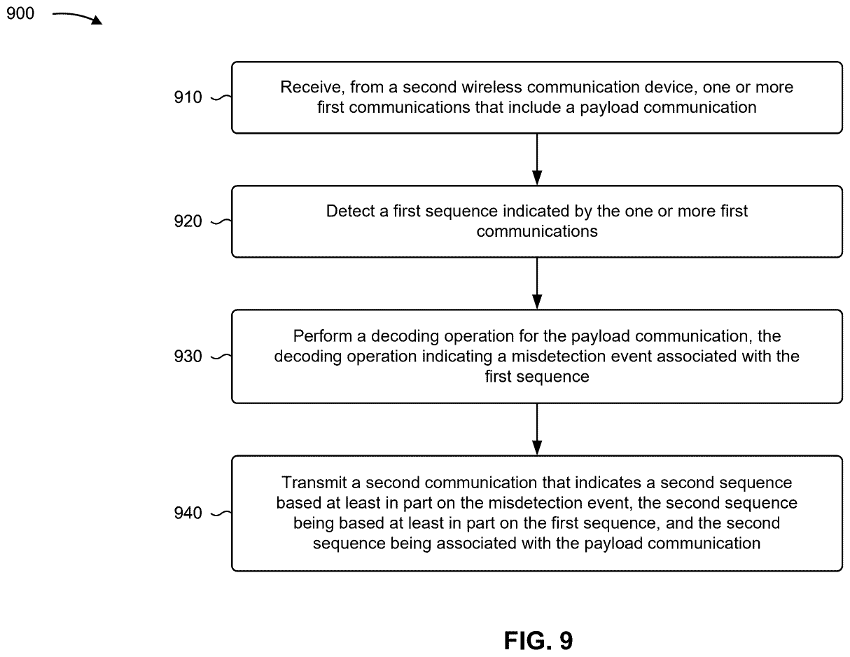

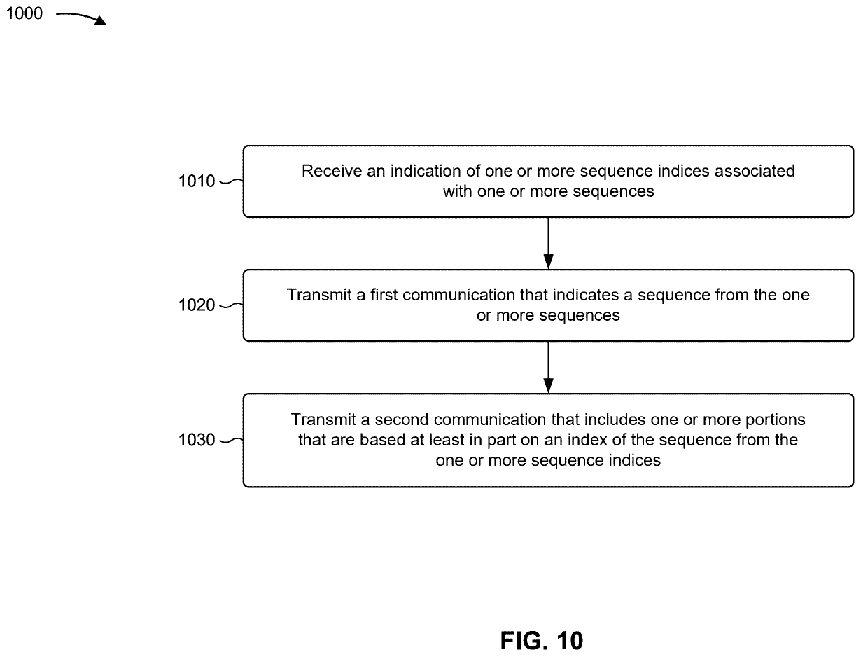

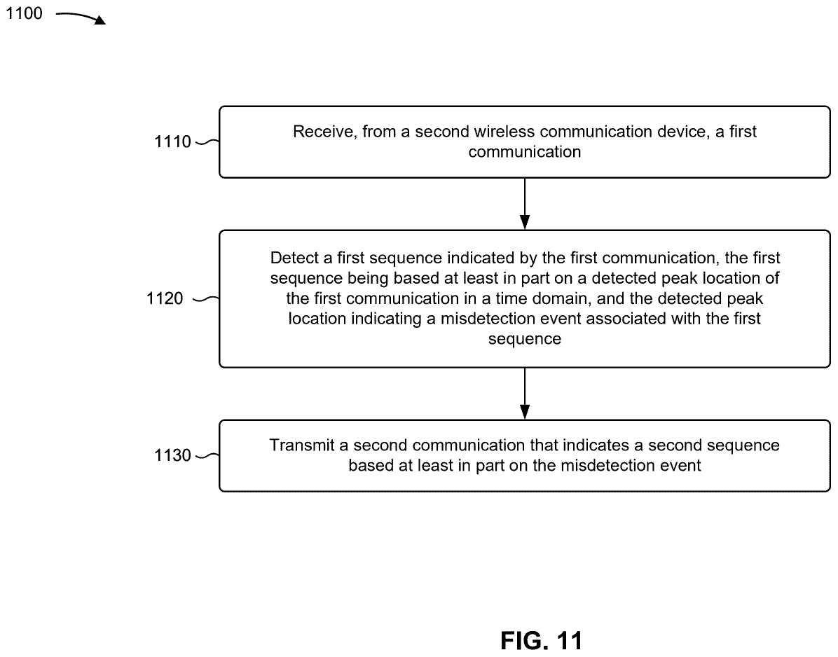

The network node 110, the processing system 145 of the network node 110, the UE 120, the processing system 140 of the UE 120, or any other component(s) of FIG. 1 may implement one or more techniques or perform one or more operations associated with a recovery mechanism for a sequence misdetection, as described in more detail elsewhere herein. For example, the processing system 145 of the network node 110, or the processing system 140 of the UE 120 may perform or direct operations of, for example, method 900 of FIG. 9, method 1000 of FIG. 10, method 1100 of FIG. 11, or other processes as described herein (alone or in conjunction with one or more other processors). In some aspects, the wireless communication device described herein is the network node 110, the UE 120, the A-IoT device 170, or the reader device 175, depending on the context. Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform method 900 of FIG. 9, method 1000 of FIG. 10, method 1100 of FIG. 11, or other processes as described herein. In some examples, executing instructions may include running the instructions, converting the instructions, compiling the instructions, or interpreting the instructions, among other examples.

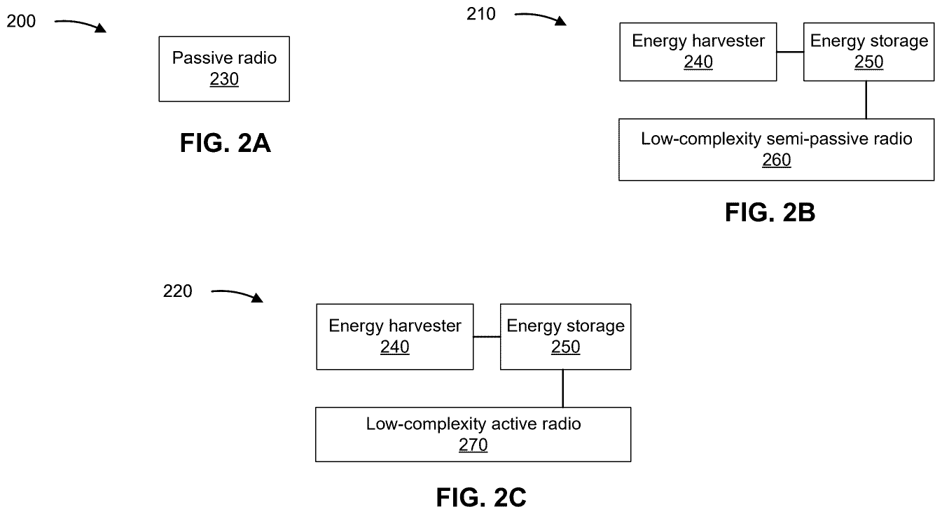

FIGS. 2A, 2B, and 2C are diagrams illustrating examples 200, 210, and 220, respectively, associated with different types of A-IoT devices. The different types of A-IoT devices may be A-IoT devices 170.

Example 200 illustrates components of a passive A-IoT device. As shown, passive A-IoT devices may include a passive radio 230. For example, the passive radio 230 may be configured to backscatter a CW.

Example 210 illustrates components of a semi-passive A-IoT device. As shown, semi-passive A-IoT devices may include an energy harvester 240, an energy storage 250, or a low-complexity semi-passive radio 260. For example, the low-complexity semi-passive radio 260 may be configured to harvest energy from a CW using the energy harvester 240, store energy from a CW using the energy storage 250, or backscatter a CW.

Example 220 illustrates components of an active A-IoT device. As shown, active A-IoT devices may include an energy harvester 240, an energy storage 250, or a low-complexity (for example, low-cost) active radio 270. For example, the low-complexity active radio 270 may be configured to harvest energy from a CW using the energy harvester 240, store energy from a CW using the energy storage 250, or backscatter a CW.

A-IoT devices may be categorized into at least three types of devices. A first type of A-IoT devices may include at least some passive or semi-passive devices. The first type of A-IoT device may have approximately 1 μW peak power consumption, support energy storage, use an initial sampling frequency offset (SFO) up to 10X ppm (for example, where X can be any suitable value), and communicate uplink transmissions by backscattering externally-provided CWs. In some examples, the first type of A-IoT devices may be referred to as a device A type or a device 1 type.

A second type of A-IoT devices may include at least some semi-passive devices. A third type of A-IoT devices may include active devices. Both the second and the third types of A-IoT devices may have less than or equal to a few hundred μW peak power consumption, support energy storage, and use an initial SFO up to 10X ppm. The second type of A-IoT device may communicate uplink transmissions by backscattering externally-provided CWs. The third type of A-IoT device may communicate uplink transmissions by internally generating the uplink transmission. In some examples, the second type of A-IoT device may be referred to as a device B type or a device 2a type. In some examples, the third type of A-IoT device may be referred to as a device C type or device 2b type.

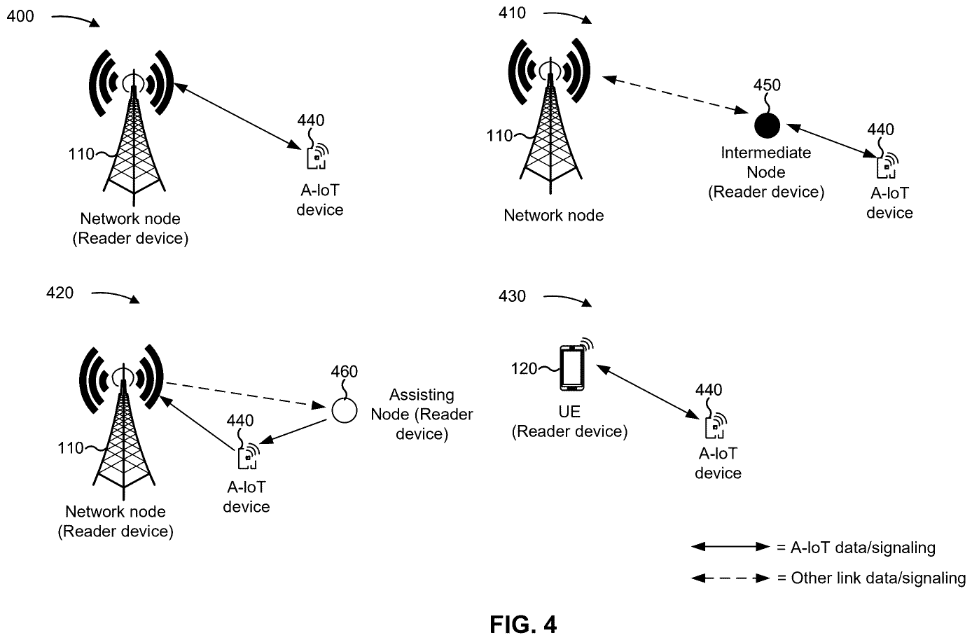

In some examples, A-IoT devices that are located indoors may support a maximum distance of 10-50 m, a range which may be sub-selected. In some examples, in Topology 1 (for example, in which an A-IoT device may directly and bidirectionally communicate with one or more network nodes 110, as described in more detail in connection with FIG. 4) and in Topology 2 (for example, in which an A-IoT device may communicate bidirectionally with an intermediate node between the A-IoT device and a network node 110, as described in more detail in connection with FIG. 4), A-IoT devices may not support RRC states, mobility (for example, cell-selection/re-selection-like functionality), automatic repeat request (ARQ), or HARQ.

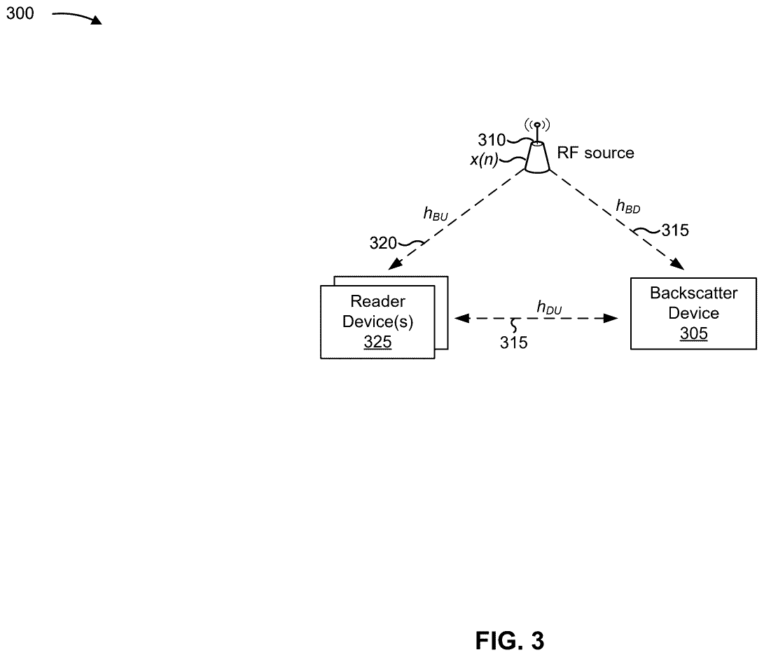

FIG. 3 is a diagram illustrating an example 300 associated with backscatter communications. As shown in FIG. 3, a backscatter device 305 (for example, an A-IoT device 170, a tag, a sensor, among other examples) may employ a simplified hardware design (for example, including a power splitter, an energy harvester, and a microcontroller). In some examples, the simplified hardware design does not include a battery, such that the backscatter device 305 relies on energy harvesting for power. Additionally, or alternatively, the simplified hardware design may not include a radio wave generation circuit, such that the backscatter device 305 is capable of transmitting information only by reflecting a radio wave. The backscatter device 305 may be one example of an A-IoT device, such as a passive, semi-passive, or active A-IoT device described with regard to FIG. 2. More particularly, the backscatter device 305 communicates with a reader device 325 (for example, the reader device 175, a UE 120, a network node 110, an energizer device (e.g., a device that provides energy for energy harvesting), or another network device) by modulating a reflecting radio signal from an RF source 310 (for example, a network node 110, a UE 120, a reader device 175, or another network device). In some examples, the RF source 310 and the reader device 325 may be the same device or may be co-located. For example, in some instances, the reader device 325 and the RF source 310 may be associated with the same network node 110.

To facilitate communication of the backscatter device 305, the RF source 310 may transmit an energy harvesting wave to the backscatter device 305. The energy harvesting wave may be transmitted for a sufficient duration in order to enable a communication phase for a target range between the reader device 325 and the backscatter device 305. Additionally, or alternatively, in some instances, a range between the RF source 310 and the backscatter device 305 may be limited by a minimum received power for triggering energy harvesting at the backscatter device 305, such as −20 decibel milliwatts (dBm).

Once energy is sufficiently accumulated at the backscatter device 305, the backscatter device 305 may begin to reflect the radio wave that is radiated onto the backscatter device 305 via a backscatter link 315. For example, the RF source 310 may initiate a communication session (sometimes referred to as a query-response communication) with a query, which may be a modulating envelope of a CW. The backscatter device 305 may respond by backscattering of the CW. The communication session may include multiple rounds, such as for purposes of contention resolution when multiple backscatter devices respond to a query. A channel between the RF source 310 and the backscatter device 305 of the backscatter link 315 may be associated with a first backscatter link channel response value (sometimes referred to as a first backscatter link channel coefficient or a first backscatter link gain value), h_{BD}. As described below, the backscatter device 305 may have reflection-on periods and reflection-off periods that follow a pattern that is based at least in part on the transmission of information bits by the backscatter device 305. The reader device 325 may detect the reflection pattern of the backscatter device 305 and obtain the backscatter communication information via the backscatter link 315. A channel between the reader device 325 and the backscatter device 305 of the backscatter link 315 may be associated with a second backscatter link channel response value (sometimes referred to as a second backscatter link channel coefficient or a second backscatter link channel gain value), h_{DU}. In addition, the RF source 310 and the reader device 325 may communicate (for example, reference signals or data signals) via a direct link 320. A channel between the RF source 310 and the reader device 325 of the direct link 320 may be associated with a direct link channel response value (sometimes referred to as a direct link channel coefficient or a direct link channel gain value), h_{BU}.

As indicated above, FIG. 3 is provided as an example. Other examples may differ from what is described with respect to FIG. 3.

FIG. 4 is a diagram illustrating examples of topologies for A-IoT devices, in accordance with the present disclosure. For example, FIG. 4 shows a first topology 400, a second topology 410, a third topology 420, and a fourth topology 430. These topologies are provided as examples and A-IoT devices may be deployed in a wireless communication network (e.g., the wireless communication network 100) in other topologies in accordance with the aspects and techniques described herein. FIG. 4 shows communication between an A-IoT device 440 (e.g., an A-IoT device similar to the device(s) described in connection with FIGS. 1, 2A, 2B, 2C, and 3) and a reader device (for example, a network node 110, an intermediate node 450, an assisting node 460, or a UE 120, depending on the topology). The topologies depicted in FIG. 4 may be examples of A-IoT systems. For example, the topologies may be deployed in a wireless communication network (e.g., the wireless communication network 100). In some examples, a reader device (e.g., the reader device 175) may be a network node 110, a UE 120, a relay, an IAB node, or a repeater, among other examples.

The first topology 400 may be referred to as Topology 1. In Topology 1, the A-IoT device 440 may directly and bidirectionally communicate with one or more network nodes 110. For example, the A-IoT 440 device and the one or more network nodes 110 may communicate A-IoT data or signaling. In some examples, a first network node 110 may transmit communications to the A-IoT device 440 and a second network node 110 may receive communications from the A-IoT device 440. In examples in which the A-IoT device 440 is deployed via the Topology 1, the network node 110 may be referred to as a reader device (e.g., a reader device as described in more detail elsewhere herein). For example, the Topology 1 may be a network node-based (or gNb-based) reader topology.

The second topology 410 may be referred to as Topology 2. In Topology 2, the A-IoT device 440 may communicate bidirectionally with an intermediate node 450 between the A-IoT device 440 and a network node 110. The intermediate node 450 may be any suitable device that is capable of A-IoT-based communication, such as a relay, an IAB node, UE (for example, a UE 120), a network node (e.g., a network node 110), or repeater, among other examples. The intermediate node 450 may transfer A-IoT

data or signaling between network node 110 and the A-IoT device. In examples in which the A-IoT device 440 is deployed via the Topology 2, the intermediate node 450 may be referred to as a reader device (e.g., a reader device as described in more detail elsewhere herein). The intermediate node 450 and the network node 110 may communicate via another link, such as an access link, a backhaul link, a midhaul link, a fronthaul link, or another communication link (e.g., and may communicate data or signaling (e.g., control signaling) via the other link). In some examples, in the Topology 2, the network node 110 may be referred to as a controller, such as a reader controller.

The third topology 420 may be referred to as Topology 3. In some examples, in Topology 3, the A-IoT 440 device may transmit A-IoT data or signaling to a network node 110 and receive A-IoT data or signaling from an assisting node 460 (e.g., sometimes referred to as Topology 3 with downlink assistance). Additionally, or alternatively, in Topology 3, the A-IoT device 440 may receive A-IoT data or signaling from the network node 110 and transmit A-IoT data or signaling to the assisting node 460 (e.g., sometimes referred to as Topology 3 with uplink assistance). The assisting node may be any suitable device that is capable of A-IoT, such as a relay, an IAB node, a UE (for example, a UE 120), a network node (e.g., a network node 110), or a repeater, among other examples. In examples in which the A-IoT device 440 is deployed via the Topology 3, both the network node 110 and the assisting node 460 may be referred to as a reader device. The assisting node 460 and the network node 110 may communicate via another link, such as an access link, a backhaul link, a midhaul link, a fronthaul link, or another communication link (e.g., and may communicate data or signaling (e.g., control signaling) via the other link). The fourth topology 430 may be referred to as Topology 4. In Topology 4, the A-IoT device 440 may bidirectionally communicate with a UE (e.g., a UE 120). For example, the A-IoT device 440 and the UE 120 may communicate A-IoT data or signaling. In examples in which the A-IoT device 440 is deployed via the Topology 4, the UE 120 may be referred to as a reader device.

A-IoT devices may be deployed in different deployment scenarios in a wireless communication network, such as the wireless communication network 100. The deployment scenarios may be categorized by environments (e.g., an indoor environment or an outdoor environment) of different devices in the deployment scenario. The devices in the different deployment scenarios may communicate using a licensed frequency division duplexing spectrum, a licensed time division duplexing spectrum, or an unlicensed spectrum. An A-IoT device may communicate both device-terminated (DT) traffic and device-originated (DO) traffic in the different deployment scenarios.

In a first deployment scenario, both an A-IoT device and a network node 110 may be deployed in an indoor environment. For example, the network node 110 may support a micro cell or a pico cell, among other examples. The devices in the first deployment scenario may be deployed using the Topology 1, the Topology 2, or the Topology 3. The A-IoT device may be the first device type, the second device type, or the third device type described in connection with FIGS. 2A-2C. The first deployment scenario may be applicable for different use cases, such as indoor inventory, indoor sensing, indoor positioning, or indoor command, among other examples.

In a second deployment scenario, an A-IoT device may be deployed in an indoor environment and a network node 110 may be deployed in an outdoor environment. For example, the network node 110 may support a macro cell or a micro cell, among other examples. In the second deployment scenario, the first device type of A-IoT devices may be deployed using the Topology 2. The second device type of IoT devices may be deployed using the Topology 2 or the Topology 3. The third device type of A-IoT devices may be deployed using the Topology 1, the Topology 2, or the Topology 3. In the second deployment scenario, other devices (e.g., a reader device, an intermediate node, or an assisting node) may be in the indoor environment or the outdoor environment. The second deployment scenario may be applicable for different use cases, such as indoor inventory, indoor sensing, indoor positioning, or indoor command, among other examples.

In a third deployment scenario, the Topology 4 may be used. The A-IoT device may be deployed in an indoor environment and may communicate with a UE-based reader device. The A-IoT device may be the first device type, the second device type, or the third device type described in connection with FIGS. 2A-2C. The third deployment scenario may be applicable for different use cases, such as indoor inventory, indoor sensing, indoor positioning, or indoor command, among other examples.

In a fourth deployment scenario, both the A-IoT device and a network node 110 may be deployed in an outdoor environment. For example, the network node 110 may support a macro cell or a micro cell, among other examples. In the fourth deployment scenario, the first device type of A-IoT devices may be deployed using the Topology 2. The second device type of IoT devices may be deployed using the Topology 2 or the Topology 3. The third device type of A-IoT devices may be deployed using the Topology 1, the Topology 2, or the Topology 3. The fourth deployment scenario may be applicable for different use cases, such as outdoor inventory, outdoor sensing, outdoor positioning, or outdoor command, among other examples.

In a fifth deployment scenario, the Topology 4 may be used. The A-IoT device may be deployed in an outdoor environment and may communicate with a UE-based reader device. The A-IoT device may be the first device type, the second device type, or the third device type described in connection with FIG. 2A-2C. The fifth deployment scenario may be applicable for different use cases, such as outdoor inventory, outdoor sensing, outdoor positioning, or outdoor command, among other examples.

As indicated above, FIG. 4 is provided as an example. Other examples may differ from what is described with respect to FIG. 4.

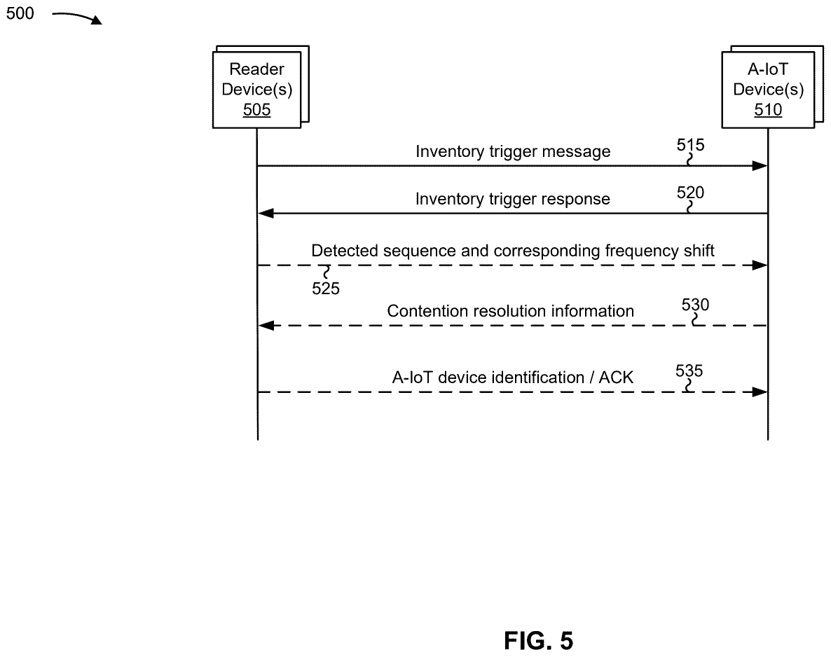

FIG. 5 is a diagram illustrating an example 500 associated with an access procedure for A-IoT devices. The access procedure may be referred to as an A-IoT access procedure, an inventory procedure, a random access procedure, or a contention-based access procedure, among other examples. As shown in FIG. 5, a reader device 505 (e.g., a reader device 175, the reader device 325, an intermediate node 450, or an assisting node 460) and one or more A-IoT devices 510 (e.g., A-IoT device 170 or another A-IoT device described herein) may communicate with one another to perform the access procedure. The reader device 505 may be a UE (e.g., the UE 120), a network node (e.g., the network node 110), or a network entity. The A-IoT device 510 may be a UE (e.g., the UE 120), a network entity, a backscatter device (e.g., the backscatter device 305), an ambient backscatter device, a terminal (such as a radio frequence identification (RFID) device, a tag, or a similar device), a passive IoT device, a semi-passive IoT device, or another type of A-IoT device, as described in more detail in connection with FIGS. 2-4. The reader device 505 and the A-IoT device 510 may operate in a topology, such as a topology described in connection with FIG. 4.

In some examples, the reader device 505 may transmit system information for A-IoT devices. For example, the system information may include access procedure configuration information. The access procedure configuration information may include one or more parameters to be used in the access procedure, such as one or more parameters for transmitting an access procedure communication or one or more parameters for receiving an access procedure communication, as described herein. The system information may include an identifier of the reader device 505. In some examples, the reader device 505 may transmit the system information via a physical channel communication. The physical channel may be a communication channel defined for reader-to-device (R2D) data transmissions (e.g., a physical R2D channel (PRDCH)).

The access procedure may be a contention-based access procedure, such as a random access procedure (e.g., an additive links online Hawaii area (ALOHA) random access procedure, a slotted-ALOHA random access procedure, or other procedures). For example, the access procedure may be an A-IoT contention-based procedure initiated by the reader device 505. “Contention-based access procedure” refers to an access procedure in which resources (e.g., transmission occasions, time-frequency resources, a unique sequence (a preamble), or other resources) for the access procedure are made available to multiple devices (e.g., multiple UEs or multiple A-IoT devices) for selection. In contention-based access procedures, a device attempting to establish access to a network may randomly select one of the resources. In contrast, non-contention-based access procedures may include a device (e.g., a network node or the reader device 505) allocating dedicated resources (e.g., transmission occasions, time-frequency resources, a unique sequence (a preamble), or other resources) for a given device to be used to establish access to the network. Contention-based access procedures may improve efficiency (e.g., because each device does not need to be allocated dedicated resources before the access procedure can be performed) or improve flexibility (such as for IoT scenarios where devices may enter and leave the network frequently).

At 515, the reader device 505 may transmit a first access procedure communication for the access procedure. The first access procedure communication may be referred to as a message 0, an Msg. 0 communication, an inventory trigger message, or a paging message (e.g., an A-IoT paging message), among other examples. The first access procedure communication may include information indicative of a set of A-IoT devices including the A-IoT device 510. For example, the first access procedure communication may include a command (e.g., a query) to indicate a specified group of A-IoT devices (e.g., including the A-IoT device 510) that are to respond (e.g., to establish a communication connection with the reader device 505). In some examples, the first access procedure communication may include identifiers of respective A-IoT devices included in the set of A-IoT devices 510. In some examples, the first access procedure communication may be interleaved among multiple first access procedure communications from respective readers. In such examples, the first access procedure communication may include an identifier of the reader device 505.

The reader device 505 may transmit the first access procedure communication to locate or identify A-IoT devices that are available in a given area at a given time. For example, the reader device 505 may be unaware of which or how many A-IoT devices 510 are available or located in a given area at a given time. Therefore, the reader device 505 may transmit the first access procedure communication (e.g., the Msg. 0 communication or an inventory trigger message) to initiate the access procedure (e.g., to enable the reader device 505 to identify which or how many A-IoT devices 510 are available and to establish a communication connection with one or more of the available A-IoT devices 510).

At 520, the A-IoT device 510 may transmit, and the reader device 505 may receive, a second access procedure communication for the access procedure. The second access procedure communication may be referred to as a message 1, an Msg. 1 communication, or an inventory trigger response, among other examples. For example, the A-IoT device 510 may receive the first access procedure communication (e.g., the Msg. 0 communication or the inventory trigger message) and identify that the A-IoT device 510 is to respond to the first access procedure communication. For example, the first access procedure communication may include an identifier of the A-IoT device 510. The A-IoT device 510 may identify that the A-IoT device 510 is to respond to the first access procedure communication based on, or otherwise associated with, the first access procedure communication including the identifier of the A-IoT device 510.

The second access procedure communication may include a sequence (sometimes referred to as a random access preamble, a PRACH preamble, an access procedure sequence, or a RAM preamble) or another cyclic-shift-based sequence. The second access procedure communication may include a preamble index. In some examples, the A-IoT device 510 may transmit the second access procedure communication with a frequency shift. For example, A-IoT devices (such as the A-IoT device 510) that receive the first access procedure communication may select a frequency shift (e.g., from a set of frequency shifts) to be used to transmit the response to the first access procedure communication (e.g., to transmit the second access procedure communication). For example, the A-IoT device 510 may support one or more frequency shifts (e.g., frequency shifts associated with a backscatter signal). For example, when transmitting the second access procedure communication, the A-IoT device 510 may apply (or add) a frequency shift to backscatter.

In some examples, the preamble or other unique sequence associated with the second access procedure communication may include an orthogonal sequence, such as a Hadamard sequence or another orthogonal sequence. Because the preambles or other unique sequences are orthogonal, the reader device 505 can distinguish between different preambles (e.g., from different A-IoT devices) even if the different preambles are transmitted at the same time. This reduces the chance that two A-IoT devices choosing the same sequence will interfere with each other, as the reader device 505 can differentiate between the signals (e.g., thereby reducing the likelihood of collisions associated with Msg. 1 communication transmissions by multiple A-IoT devices).

However, as described herein, transmissions between the A-IoT device 510 and the reader device 505 may experience SFO. The SFO may introduce frequency errors that can lead to time errors in the transmissions by the A-IoT device 510. The time errors may result in non-orthogonality between sequences detected by the reader device 505. For example, the time errors can cause a detected peak of a transmitted sequence to shift from an original time window to an adjacent time window (e.g., where the adjacent time window is associated with a different sequence). This may result in a misdetection of the sequence by the reader device 505 (e.g., the reader device 505 may detect the different sequence rather than the sequence transmitted by the A-IoT device 510). The sequence misdetection may result in a misidentification of the A-IoT device 510, or a failure of a cyclic-shift-based communication (such as the access procedure described herein).

The second access procedure communication may include a sequence communication and a payload communication. The sequence communication may indicate the sequence generated or selected by the A-IoT device 510. The payload communication may include a payload. The payload may include data. In some examples, the payload communication may include a channel estimate reference signal, such as a DMRS, among other examples. The reader device 505 may measure the channel estimate reference signal to perform channel estimation for a channel between the reader device 505 and the A-IoT device 510.

In some aspects, at 525, the reader device 505 may transmit, and the A-IoT device 510 may receive, a third access procedure communication. The third access procedure communication may be referred to as a message 2, an Msg. 2 communication, or a random access response, among other examples. The third access procedure communication may include information indicative of the sequence (e.g., the preamble) included in the second access procedure communication. Additionally, or alternatively, the third access procedure communication may include information indicative of the detected frequency shift applied to the second access procedure communication transmitted by the A-IoT device 510. Additionally, or alternatively, the third access procedure communication may indicate a resource allocation to be used by the A-IoT device 510 to transmit a fourth access procedure communication (e.g., as described at 530).

At 530, the A-IoT device 510 may transmit, and the reader device 505 may receive, a fourth access procedure communication. The fourth access procedure communication may be referred to as a message 3, an Msg. 3 communication, or a connection request message, among other examples. For example, the A-IoT device 510 may transmit the fourth access procedure communication based on, in response to, or otherwise associated with detecting the third access procedure communication that includes information indicative of the sequence transmitted by the A-IoT device 510 (e.g., in the second access procedure communication) or of the frequency shift applied by the A-IoT device 510.

The fourth access procedure communication may include data. For example, the fourth access procedure communication may include information indicative of a device type, an identifier, a group, or other information about the A-IoT device 510. The reader device 505 may use the information included in the fourth access procedure communication for contention resolution.

In some aspects, at 535, the reader device 505 may transmit, and the A-IoT device 510 may receive, a fifth access procedure communication. The fifth access procedure communication may be referred to as a feedback indication (e.g., a failure (e.g., negative acknowledgement (NACK)) or success feedback indication (e.g., an acknowledgement (ACK)), a Msg. 2 retransmission, a message 4, a Msg. 4 communication, or a connection setup message, among other examples. In some examples, the fifth access procedure communication may include the detected A-IoT device identifier, a timing advance value, or contention resolution information. The reader device 505 and the A-IoT device 510 may establish a communication connection based on, or otherwise associated with, the communication of the fifth access procedure communication.

The access procedure depicted and described in connection with FIG. 5 is an example of a four-step (or five-step) access procedure. In other examples, a one-step access procedure (e.g., in which only the communications at 515 and at 520 are communicated), a two-step access procedure (e.g., in which only the communications at 515, at 520, and at 535 are communicated), a three-step access procedure (e.g., in which only the communications at 515, at 520, and at 530 are communicated), or another type of access procedure may be performed in a similar manner. For example, in a two-step access procedure, information described herein that is included in the Msg. 1 communication at 520 and the Msg. 3 communication at 530 may be included in a single message (e.g., a message A or an Msg. A). Additionally, or alternatively, information described herein that is included in the Msg. 2 communication at 525 and the feedback indication at 535 may be included in a single message (e.g., a message B or an Msg. B).

As indicated above, FIG. 5 is provided as an example. Other examples may differ from what is described with respect to FIG. 5.

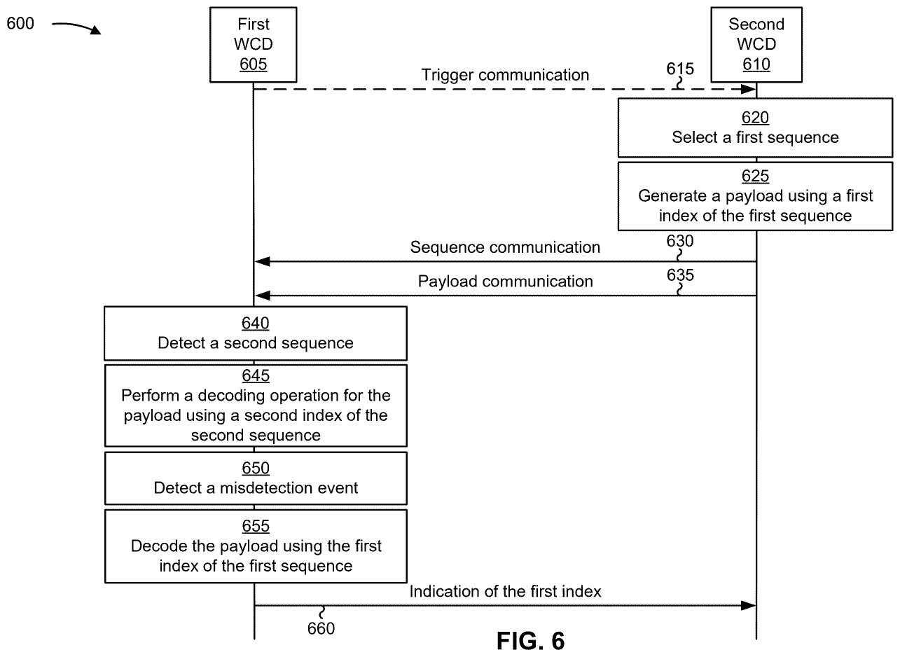

FIG. 6 is a diagram of an example 600 associated with a recovery mechanism for a sequence misdetection. As shown in FIG. 6, a first wireless communication device (WCD) 605 (e.g., a network node 110, a UE 120, a reader device 175, a reader device 505, an intermediate node 450, or an assisting node 460) may communicate with a second WCD 610 (e.g., a UE 120, an A-IoT device 170, a backscatter device 305, an A-IoT device 440, or an A-IoT device 510). In some aspects, the first WCD 605 and the second WCD 610 may be part of a wireless network (e.g., the wireless communication network 100). In some aspects, the first WCD 605 may be a reader device, such as in a deployment or topology described in connection with FIG. 4. In such examples, the second WCD 610 may be an A-IoT device that is configured to communicate with the reader device.

Although some examples are described herein in connection with A-IoT devices, the techniques and aspects described herein may be similarly applied for other types of devices, such as IoT devices, EH-capable devices, RedCap UEs, eRedCap UEs, MTC UEs, other devices having limited or reduced capabilities (e.g., as compared to a baseline device or baseline UE), or baseline UEs. Additionally, although some examples are described herein in connection with certain types of communications, such as random access communications, inventory trigger communications, or command communications, the techniques and aspects described herein may be similarly applied for any type of cyclic-shift-based communication or sequence-based communication.

In some aspects, the operations depicted and described in connection with FIG. 6 may be associated with a procedure, such as an access procedure or an inventory procedure (e.g., in a similar manner as described in connection with FIG. 5), a feedback procedure, or another cyclic-shift-based communication procedure. The access procedure or inventory procedure may be a random access procedure or an A-IoT inventory procedure. In some examples, the procedure may be a one-step procedure or a two-step procedure, such as a one-step or two-step access procedure or an inventory procedure.

In some aspects, the second WCD 610 may optionally transmit, and the first WCD 605 may receive, device information or capability information. The second WCD 610 may transmit the device information via a backscatter signal, a backward signal, a device-to-reader (D2R) communication, a D2R data communication, a broadcast channel, an uplink communication, a UE assistance information (UAI) communication, a UCI communication, or a MAC-CE communication, among other examples. The device information may indicate one or more parameters associated with respective capabilities of the second WCD 610. The one or more parameters may be indicated via respective information elements (IEs) included in a capability report.

The device information may indicate whether the second WCD 610 supports a feature or one or more parameters related to the feature. For example, the device information may indicate a capability or device type or parameter for generating a portion of a payload communication in association with, based on, or otherwise using an index of a sequence transmitted via a sequence communication. For example, the capability or device type information may indicate that the second WCD 610 supports generating the portion of the payload communication using the index of the sequence as an input. The indication may be explicit with capability information or implicit by indicating device type information. In some aspects, the device information may indicate a capability or device type or parameter for generating a channel estimate reference signal (such as a DMRS, a CSI reference signal, a positioning reference signal, a tracking reference signal, or another type of reference signal) in association with, based on, or otherwise using an index of a sequence transmitted via a sequence communication. In some aspects, the device information may indicate a capability or device type or parameter for generating data (e.g., to be included in a payload of the payload communication) in association with, based on, or otherwise using an index of a sequence transmitted via a sequence communication.

One or more operations described herein may be based on device information. For example, the second WCD 610 may perform a communication in accordance with the device information, or may receive configuration information that is in accordance with the device information. In some aspects, the device information may indicate a type or group associated with the second WCD 610, such as a device 1 type A-IoT devices, device 2A type A-IoT devices, or device 2B type A-IoT device, among other examples. In some aspects, the device information may indicate an identifier of the second WCD 610 (e.g., device ID).

In some aspects, the second WCD 610 may be preconfigured or programmed with the device information before being activated or deployed for an application or service (e.g., via a manufacturer or a service provider) where the device information may be stored at the second WCD 610. In some aspects, the second WCD 610 may be configured or programmed with the device information by the first WCD 605 (e.g., before or during activation) for an application or service.

In some aspects, the first WCD 605 may optionally transmit, and the second WCD 610 may receive, configuration information. In some aspects, the second WCD 610 may receive the configuration information via one or more of system information signaling (e.g., a master information block (MIB) or a system information block (SIB), among other examples), an R2D communication, an R2D data channel communication, an R2D control channel communication, an access link, a forward link, RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the second WCD 610 or previously indicated by the network node or other network device), or explicit configuration information for the second WCD 610 to use to configure the second WCD 610, among other examples.

In some examples, the configuration information may not be expressly signaled to the second WCD 610. For example, in some aspects, the configuration information may at least partially be defined by a wireless communication standard, such as the 3GPP. In such examples, the first WCD 605 may not explicitly indicate such configuration information to the second WCD 610. For example, the second WCD 610 may optionally obtain at least a portion of the configuration information from a configuration stored by the second WCD 610 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the second WCD 610 is to transmit a payload communication (e.g., a communication that includes a payload) that is in association with, based on, or otherwise generated using an index of a sequence (e.g., a sequence transmitted in a sequence communication, such as a random access communication or an inventory procedure communication). As used herein, “payload” refers to the part of transmitted data that is an intended message or information (e.g., excluding any headers or metadata used for routing and processing). In the context of wireless communication, the payload can include various types of data, such as user information, control information, or application-specific data, among other examples. In some examples, the payload may include one or more reference signals, such as a DMRS or other channel estimate reference signals (e.g., which are used to facilitate accurate data transmission and reception by providing channel state information). The one or more reference signals may be interspersed with the data within the payload to enable accurate channel estimation and data decoding. In the payload, a reference signal (such as a DMRS) may be placed at specific intervals or positions relative to the data. This placement allows a receiving device (e.g., the first WCD 605) to perform channel estimation and compensate for any channel impairments, thereby improving the reliability and accuracy of the data decoding process. The positioning of these reference signals can vary depending on the communication protocol and the specific requirements of the transmission.

In some aspects, the configuration information may indicate that the second WCD 610 is to generate a portion of the payload in association with, based on, or otherwise using an index of a sequence (e.g., a sequence index). In some aspects, the configuration information may indicate that the portion is a reference signal, such as DMRS or another channel estimate reference signal. In some aspects, the configuration information may indicate that the portion is data to be included in the payload. The configuration information may indicate that the second WCD 610 is to generate the portion of the payload using the index of the sequence as an input. For example, the index may be used to initialize the generation of the portion, ensuring that the portion is uniquely associated with, or tied to, the index of the sequence to be transmitted by the second WCD 610. As another example, the index may be derived from an algorithm and then used to compute one or more parameters of the payload, such as scrambling codes or modulation schemes. In some aspects, the index may be used to scramble the portion of the payload.

In some aspects, the configuration information may indicate a set of sequence indices that are available for use by the second WCD 610. For example, the first WCD 605 may transmit, and the second WCD 610 may receive, an indication of a set of sequence indices. For example, the first WCD 605 may provide the set of sequence indices (e.g., a pool of sequence indices) that can be used by the second WCD 610 for a cyclic-shift-based communication or a sequence-based communication, such as the sequence communication at 630. For example, in a cyclic-shift-based communication scenario, the second WCD 610 may use a sequence corresponding to a sequence index (e.g., indicated by the set of sequence indices) to perform a cyclic shift on transmitted signals, thereby ensuring orthogonality and reducing interference with other communications. Further, by the first WCD 605 transmitting the set of sequence indices, the first WCD 605 may have improved flexibility and adaptability in the communication process. The first WCD 605 may select different sequence indices based on current communication conditions, such as channel quality, interference levels, or a quantity of WCDs (e.g., A-IoT devices) operating in a given area, thereby optimizing its transmission performance.

The second WCD 610 may configure itself based at least in part on the configuration information. In some aspects, the second WCD 610 may be configured to perform one or more operations described herein based at least in part on the configuration information.

At 615, the first WCD 605 may transmit, and the second WCD 610 may receive, a trigger communication. The trigger communication may be similar to the first access procedure communication (e.g., the inventory trigger message) described in connection with FIG. 5 at 515. The trigger communication may be referred to as a message 0, an Msg. 0 communication, an inventory trigger message, or a paging message (e.g., an A-IoT paging message), among other examples. The trigger communication may include information indicative of a set of WCDs (e.g., a set of A-IoT devices) including the second WCD 610. For example, the trigger communication may include a command (e.g., a query) to indicate a specified group of WCDs (e.g., including the second WCD 610) that are to respond (e.g., to establish a communication connection with the first WCD 605). In some examples, the trigger communication may include identifiers of respective WCDs included in the set of WCDs.

The first WCD 605 may transmit the trigger communication to locate or identify WCDs (such as the second WCD 610) that are available in a given area at a given time. For example, the first WCD 605 may be unaware of which or how many WCDs are available or located in a given area at a given time. Therefore, the first WCD 605 may transmit the trigger communication to initiate the access procedure or an inventory procedure (e.g., to enable the first WCD 605 to identify which or how many WCDs are available and to establish a communication connection with one or more of the available WCDs). In some examples, the first WCD 605 may transmit the trigger communication via an R2D channel.

In some aspects, the trigger communication may indicate the set of sequence indices that are available for use by the second WCD 610 (e.g., described above in connection with the configuration information). For example, the first WCD 605 may indicate one or more sequences (e.g., by indicating one or more sequence indices) that can be used by the second WCD 610 in a response (e.g., a sequence communication) to the first WCD 605. In some aspects, the trigger communication may indicate which portion of a payload communication (such as the payload communication at 635) is to be associated with (e.g., generated using) an index of a selected sequence.

At 620, the second WCD 610 may select a first sequence. The second WCD 610 may select the first sequence from the set of sequences (e.g., indicated by the set of sequence indices) indicated by the first WCD 605 as being available for use. In some aspects, the second WCD 610 may randomly select the first sequence from the set of sequences. The first sequence may be associated with a first index (e.g., a first sequence index). The first index may identify the first sequence. The first sequence may be associated with a cyclic shift. For example, the first sequence may be based on a root sequence and the cyclic shift (e.g., the second WCD 610 may generate the first sequence by applying the cyclic shift to the root sequence).

At 625, the second WCD 610 may generate a payload using the first index of the first sequence. For example, the second WCD 610 may generate one or more portions of the payload in association with, based on, or otherwise using the first index. This ensures that the payload is uniquely associated with or tied to the sequence selected by the second WCD 610 at 620. By associating at least a portion of the payload with the sequence selected by the second WCD 610, the first WCD 605 can use the index of a detected sequence during a decoding operation to detect and correct sequence misdetections, as explained in more detail elsewhere herein (such as at 645, at 650, or at 655).

In some aspects, the second WCD 610 may generate one or more portions of the payload using the first index as an input. For example, the second WCD 610 may initialize, derive, compute, calculate, scramble, or otherwise generate the one or more portions using the first index. In some aspects, the second WCD 610 may derive or compute one or more parameters of the payload, such as scrambling codes or modulation schemes, based on the first index. As another example, the second WCD 610 may use the first index to scramble the data of the payload.

In some aspects, the one or more portions of the payload may include a channel estimate reference signal, such as a DMRS. The second WCD 610 may generate the channel estimate reference signal in association with, based on, or otherwise using the first index. For example, the second WCD 610 may initialize a scrambling sequence for the channel estimate reference signal (e.g., for the DMRS) using the first index. For example, the second WCD 610 may use the first index as a scrambling identifier for scrambling initialization. As another example, the second WCD 610 may select, compute, initialize, or otherwise determine one or more parameters of the channel estimate reference signal based on the first index. For example, the second WCD 610 may select, compute, initialize, or otherwise determine a configuration type (e.g., a DMRS-config-type), a frequency mapping (e.g., a resource element mapping, or a mapping type), a time domain resource allocation, among other examples, based on the first index. For example, the first index may be mapped to, or associated with, a value or setting of the one or more parameters of the channel estimate reference signal.

In some aspects, the one or more portions of the payload may include data (e.g., a payload or bitstream). For example, the second WCD 610 may obtain data to be included in the payload. The second WCD 610 may generate data to be included in the payload using the obtained data and the first index. For example, the second WCD 610 may use the first index to scramble the obtained data, ensuring that the data is uniquely associated with the specific sequence. This scrambling process can involve applying a mathematical operation or algorithm that uses the first index as a key, thereby transforming the data into a form that can only be correctly interpreted using the first index. As another example, the second WCD 610 may use the first index to initialize or seed a pseudo-random number generator that produces a sequence of values used to modify the obtained data. This ensures that the data is uniquely tied to, or associated with, the first index. The generated data may also be encoded or modulated based on the first index. In some aspects, the second WCD 610 may use the first index to derive or determine one or more parameters for data generation, such as coding rates, interleaving patterns, or error correction schemes, among other examples.

The second WCD 610 may transmit, and the first WCD 605 may receive, one or more communications. The one or more communications may include a sequence communication or a payload communication. For example, at 630, the second WCD 610 may transmit, and the first WCD 605 may receive, a sequence communication. The sequence communication may indicate, or include, the first sequence (e.g., that was selected by the second WCD 610 at 620). The second WCD 610 may transmit the sequence communication using first one or more time resources (e.g., during a first time instance). The sequence communication may be a first channel communication. For example, the first channel may be a sequence-based channel (e.g., similar to a physical random access channel (PRACH)). The first channel may be a first D2R channel.

At 635, the second WCD 610 may transmit, and the first WCD 605 may receive, a payload communication. The payload communication may include the payload (e.g., generated by the second WCD 610 at 625). The second WCD 610 may transmit the sequence communication using second one or more time resources (e.g., during a second time instance). The second one or more time resources may be different than the first one or more time resources (e.g., that are used to transmit the sequence communication at 630). For example, the second WCD 610 may transmit the sequence communication at 630 during the first time instance and the payload communication at 635 during the second time instance. The first time instance may occur before the second time instance. In other aspects, the first time instance may occur after the second time instance. An amount of time between the first time instance and the second time instance may satisfy a time threshold (e.g., the second WCD 610 may transmit the sequence communication at 630 and the payload communication at 635 during different time instances that are relatively close together).

The payload communication may be a second channel communication. The second channel may be different than the first channel (e.g., that is used to transmit the sequence communication at 630). For example, the second channel may be a data channel (e.g., similar to a physical shared channel, such as the PUSCH or the PDSCH). The second channel may be a second D2R channel.

At 640, the first WCD 605 may perform a detection operation in association with, based on, or using the sequence communication. For example, the first WCD 605 may sample one or more time domain samples of the sequence communication to detect a peak location (e.g., a detected peak location). The detected peak location may be one or more time domain samples having a highest received power (e.g., among a set of time domain samples). The location of the detected peak location in the time domain may indicate the sequence indicated by the sequence communication. For example, as different sequences may be cyclic-shifted versions of a root sequence, each sequence may be associated with a respective sequence window in the time domain. If the detected peak location occurs within a given sequence window, then the first WCD 605 may detect that the sequence is a sequence corresponding to the given sequence window. The first WCD 605 may perform the detection operation using one or more PHY layer (or Layer 1) components, such as by measuring or sampling one or more time domain samples of the sequence communication.

As shown in FIG. 6, at 640, the first WCD 605 may detect a second sequence. The second sequence may be different than the first sequence (e.g., that is selected by the second WCD 610 at 620 or indicated by the sequence communication at 630). For example, the sequence communication may experience SFO which results in a time domain error or shift in the detected peak location. This may result in a sequence misdetection by the first WCD 605 if the time domain error or shift causes the detected peak location to occur during a sequence window corresponding to a sequence (e.g., the second sequence) that is different than the sequence that is selected by the second WCD 610 at 620 or transmitted via the sequence communication at 630). For example, when the peak of the received signal shifts due to SFO, the detected peak may fall within the time window of an adjacent sequence (e.g., adjacent to the sequence actually transmitted by the second WCD 610 at 630), resulting in the first WCD 605 detecting the adjacent sequence at 640 rather than the sequence actually transmitted by the second WCD 610 at 630. As used herein, “adjacent” in the context of sequences may refer to a sequence that has a sequence window directly next to (e.g., directly before or after) a sequence window of a given sequence. For example, if an index of a given sequence is N, then an adjacent sequence may have an index of N+1 or N−1.

In some aspects, the first WCD 605 may identify or determine one or more candidate sequences for decoding the payload communication. As described in more detail elsewhere herein, the first WCD 605 may attempt to decode the payload communication using an index of the sequence detected at 640 (e.g., a second index of the second sequence). The one or more candidate sequences may be sequences that can also be used to decode the payload communication (e.g., in addition to the sequence detected at 640). For example, if a misdetection event (e.g., a sequence misdetection) occurs, then the decoding of the payload may fail using the index of the sequence detected at 640. Therefore, the first WCD 605 may identify or determine one or more candidate sequences that can also be used to decode the payload to correct or mitigate the misdetection event.

The first WCD 605 may identify or determine one or more candidate sequences based on the detected peak location of the sequence detected at 640. In some aspects, one or more PHY layer (or Layer 1) components may provide, and one or more MAC layer (or Layer 2) components of the first WCD 605 may obtain, the index sequence detected at 640 (e.g., the second index). The one or more MAC layer (or Layer 2) components may identify or determine one or more candidate sequences based on the detected peak location of the sequence detected at 640. The one or more MAC layer (or Layer 2) components may provide, and the one or more PHY layer (or Layer 1) components may obtain, one or more indices of the one or more candidate sequences for a decoding operation. For example, the first WCD 605 may identify candidate sequences as adjacent sequences by analyzing the detected peak location in the time domain. If the detected peak is near the boundary of the expected sequence window, the first WCD 605 may consider the sequence in the adjacent time windows as a candidate sequence.

For example, if the detected peak location falls slightly before or after the center of the expected sequence window, then the first WCD 605 may determine that the actual transmitted sequence could be either the current sequence or one of the adjacent sequences. By considering the adjacent sequences as candidate sequences, the first WCD 605 can perform additional decoding attempts using the indices of those candidate sequences. This approach allows the first WCD 605 to account for potential time domain shifts caused by SFO or other timing errors, thereby increasing the likelihood of correctly identifying the transmitted sequence and accurately decoding the payload. By evaluating the detected peak location and the proximity to the boundaries of the sequence window, the first WCD 605 can effectively narrow down the possible sequences to a small set of candidate sequences. This process enhances the robustness of the communication system, ensuring that even in the presence of timing errors, the first WCD 605 can accurately identify and decode the transmitted data from the second WCD 610.

At 645, the first WCD 605 may perform a decoding operation for the payload (e.g., of the payload communication received at 635) using the second index of the second sequence that was detected at 640. In some aspects, the decoding operation may be in association with, may be based on, or may otherwise use the index (e.g., the second index) of the sequence (e.g., the second sequence) detected by the first WCD 605 at 640. For example, the first WCD 605 may attempt to decode the payload based on, using, or otherwise associated with the second index. If the decoding operation is successful (e.g., if a cyclic redundancy check (CRC) or other error checking operation passes), then the first WCD 605 may determine that the sequence (e.g., the second sequence) detected by the first WCD 605 at 640 was correctly detected (e.g., and may proceed with transmitting an acknowledgement communication to the second WCD 610 at 660).

However, at 650, if the decoding operation is unsuccessful (e.g., if a CRC or other error checking operation fails), then the first WCD 605 may detect or identify a misdetection event. A misdetection event may be indicative of a sequence misdetection at 640. As a result, by at least a portion of the payload being associated with (e.g., generated using) the index of the sequence transmitted by the second WCD 610 at 630, the first WCD 605 can use an index of the sequence detected at 640 to determine whether a sequence misdetection has occurred.

For example, as described herein, the portion of the payload that is associated with (e.g., generated using) the index of the sequence transmitted by the second WCD 610 at 630 may be a channel estimate reference signal, such as a DMRS. In some aspects, the decoding operation at 645 may include performing a channel estimation using the channel estimate reference signal of the payload communication (e.g., and the second index of the second sequence detected at 640 if the portion generated using the index is the channel estimate reference signal). For example, the channel estimate reference signal (e.g., a DMRS) may be a known signal or sequence embedded within data included in the payload. The first WCD 605 may receive the DMRS and may compare the received signals with the known reference signal to estimate the impact of a wireless communication channel, such as fading, noise, and interference. For example, the first WCD 605 may obtain one or more channel estimation values, such as a signal-to-noise ratio (SNR), an RSSI, or another signal quality metric value. If the channel estimate reference signal (e.g., the DMRS) is not generated using the sequence index at 625, then the first WCD 605 may perform the channel estimation without using the index of the sequence detected by the first WCD 605 at 640 (e.g., the second sequence).

If the channel estimate reference signal (e.g., the DMRS) is generated using the sequence index at 625, then the first WCD 605 may perform the channel estimation based on, using, or otherwise associated with the index of the sequence detected by the first WCD 605 at 640 (e.g., the second sequence). For example, the first WCD 605 may identify one or more parameters of the channel estimate reference signal (e.g., a frequency mapping, a mapping type, a time domain resource allocation, a frequence resource allocation, or another parameter) based on the index of the sequence detected by the first WCD 605 at 640 (e.g., the second sequence). The first WCD 605 may use the one or more parameters to extract or measure the channel estimate reference signal included in the payload. As another example, the first WCD 605 may identify or determine a scrambling sequence of the channel estimate reference signal based on the sequence detected by the first WCD 605 at 640 (e.g., the second sequence). The first WCD 605 may use the scrambling sequence as a known sequence when comparing the received channel estimate reference signal to the known sequence.

If the one or more channel estimation values satisfy a misdetection threshold, then the first WCD 605 may determine that a misdetection event has not occurred. For example, if the one or more channel estimation values satisfy the misdetection threshold, then the first WCD 605 may determine that the sequence was correctly detected at 640. If the one or more channel estimation values do not satisfy the misdetection threshold, then the first WCD 605 may determine that a misdetection event has occurred. For example, if the channel estimation (e.g., that is performed based on or using the index of the sequence detected at 640) is poor, the first WCD 605 may determine that the sequence was not correctly detected at 640.

In such examples, the first WCD 605 may re-perform the channel estimation operation using one or more indices of one or more candidate sequences, such as one or more sequences adjacent to the sequence detected at 640. For example, the first WCD 605 may repeat the channel estimation operation with one or more of the adjacent sequence indices until the one or more channel estimation values satisfy the misdetection threshold. If the one or more channel estimation values do not satisfy the misdetection threshold when using any of the indices of one or more candidate sequences, then the first WCD 605 may determine that the wireless communication channel is poor and the payload cannot be decoded.

If one or more channel estimation values (e.g., obtained from performing a channel estimation operation using an index of a given candidate sequence) satisfy the misdetection threshold, then the first WCD 605 may determine that the given candidate sequence is the actually transmitted sequence that was transmitted by the second WCD 610 at 630. For example, the first WCD 605 may identify the first sequence (e.g., that was selected by the second WCD 610 at 620) as a candidate sequence. Based on a misdetection event occurring (e.g., when performing channel estimation using the second index of the second sequence detected by the first WCD 605 at 640), at 655, the first WCD 605 may perform channel estimation for the payload using the first index of the first sequence (e.g., if the first sequence is identified as a candidate sequence). Because the channel estimate reference signal (e.g., the DMRS) in the payload was generated using the first sequence, the one or more channel estimation values obtained from the channel estimation operation may satisfy the misdetection threshold, indicating that the first sequence was the actually transmitted sequence. In such examples, at 655, the first WCD 605 may decode the payload communication based on, using, or otherwise associated with the one or more channel estimation values obtained from the channel estimation operation (e.g., that was performed using the first index).

In some other aspects, the data included in the payload may be associated with (e.g., generated using) the sequence index. In such examples, the first WCD 605 may perform channel estimation for the payload communication independent of the detected sequence index (e.g., the second index). The first WCD 605 may attempt to decode the data based on the channel estimation and the index of the sequence detected by the first WCD 605 at 640 (e.g., the second sequence). For example, the second index may be an input to the decoding operation.

As an example, the first WCD 605 may use the second index to initialize or seed a decoding algorithm, ensuring that the decoding process is aligned with the sequence detected by the first WCD 605. The first WCD 605 may use the second index to attempt to apply specific decoding parameters, such as de-scrambling codes, error correction codes, or interleaving patterns, that were originally used by the second WCD 610 to encode or generate the data. The first WCD 605 may determine whether the decoding of the data using the second sequence is successful. For example, the first WCD 605 may determine whether a CRC for the decoding operation at 645 passes. If the decoding of the data using the second sequence is unsuccessful at 645, then the first WCD 605 may detect or identify the misdetection event at 650. For example, if the first WCD 605 is unable to decode the data using the index (e.g., the second index) detected by the first WCD 605 at 640, then the first WCD 605 may determine that there was a sequence misdetection at 640.

In such examples, at 655, the first WCD 605 may attempt to decode the data using indices of one or more candidate sequences. For example, the first WCD 605 may attempt to decode the data using one or more adjacent sequences to the sequence detected at 640. In other examples, the one or more candidate sequences may not be adjacent to the detected sequence (e.g., if the detected sequence at 640 has an index N, the one or more candidate sequences may have indices N+1, N−1, N+2, N−2, and so on). As an example, the first WCD 605 may identify the first sequence (e.g., that was actually transmitted by the second WCD 610 at 630) as a candidate sequence. The first WCD 605 may attempt to decode the data using the first index of the first sequence. Because the second WCD 610 used the first index to generate the data at 625, the first WCD 605 may be able to successfully decode the data using the first index. For example, a CRC for the decoding operation using the first index may pass. In other words, if a misdetection event occurs, the first WCD 605 may attempt to decode the data (or payload) using indices of one or more candidate sequences until a CRC for the decoding operation passes. This enables the first WCD 605 to identify and correct a sequence misdetection (e.g., without any additional signaling between the first WCD 605 and the second WCD 610). This reduces latency, conserves energy, or conserves network resources that would have otherwise been associated with additional signaling between the first WCD 605 and the second WCD 610 due to the misdetection event.

At 660, the first WCD 605 may transmit, and the second WCD 610 may receive, an indication of the first index. For example, the first WCD 605 may transmit a communication that indicates the first sequence (e.g., based at least in part on the misdetection event occurring and the first WCD 605 performing one or more actions to identify an actually transmitted sequence, such as at 655). In some aspects, the communication may indicate that the first sequence is associated with the payload communication communicated at 635. For example, the communication may be a feedback communication (e.g., an ACK indication) that indicates that the payload communication communicated at 635 was successfully received and decoded by the first WCD 605. The first sequence may be included in the communication to enable the second WCD 610 to identify that the feedback communication (e.g., an ACK indication) is intended for the second WCD 610. In some aspects, the communication may be similar to the fifth access procedure communication described in connection with FIG. 5 at 535.

As indicated above, FIG. 6 is provided as an example. Other examples may differ from what is described with respect to FIG. 6.

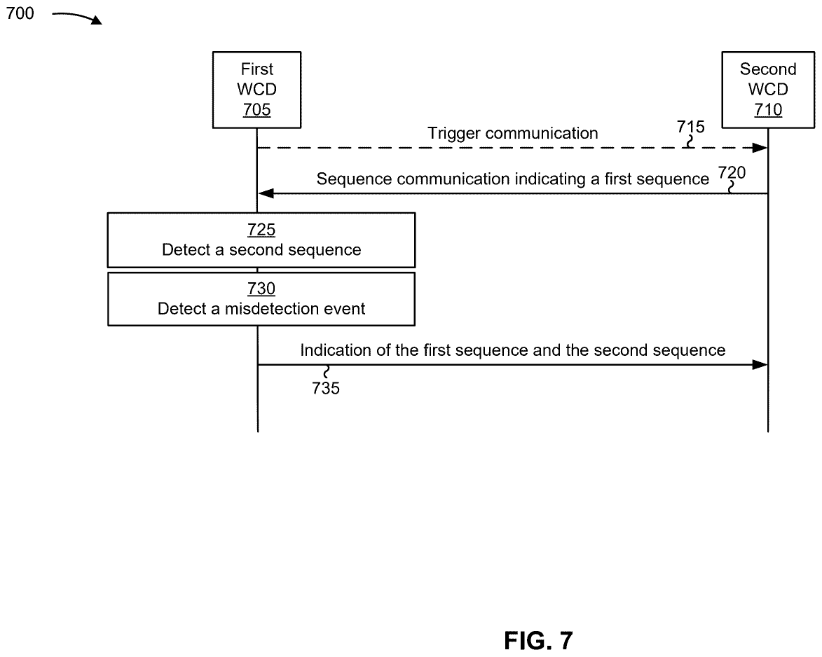

FIG. 7 is a diagram of an example 700 associated with a recovery mechanism for a sequence misdetection. As shown in FIG. 7, a first WCD 705 (e.g., the first WCD 605, a network node 110, a UE 120, a reader device 175, a reader device 505, an intermediate node 450, or an assisting node 460) may communicate with a second WCD 710 (e.g., the second WCD 610, a UE 120, an A-IoT device 170, a backscatter device 305, an A-IoT device 440, or an A-IoT device 510). In some aspects, the first WCD 705 and the second WCD 710 may be part of a wireless network (e.g., the wireless communication network 100). In some aspects, the first WCD 705 may be a reader device, such as in a deployment or topology described in connection with FIG. 4. In such examples, the second WCD 710 may be an A-IoT device that is configured to communicate with the reader device.

Although some examples are described herein in connection with A-IoT devices, the techniques and aspects described herein may be similarly applied for other types of devices, such as IoT devices, EH-capable devices, RedCap UEs, eRedCap UEs, MTC UEs, other devices having limited or reduced capabilities (e.g., as compared to a baseline device or baseline UE), or baseline UEs. Additionally, although some examples are described herein in connection with certain types of communications, such as random access communications, inventory trigger communications, or command communications, the techniques and aspects described herein may be similarly applied for any type of cyclic-shift-based communication or sequence-based communication.

In some aspects, the operations depicted and described in connection with FIG. 7 may be associated with a procedure, such as an access procedure or an inventory procedure (e.g., in a similar manner as described in connection with FIG. 5), a feedback procedure, or another cyclic-shift-based communication procedure. The access procedure or inventory procedure may be a random access procedure or an A-IoT inventory procedure. In some examples, the procedure may be a three-step procedure or a four-step procedure, such as a three-step or four-step access procedure or an inventory procedure, or another procedure in which a sequence or cyclic-shift-based communication is transmitted separate from (or without association with) a payload communication.

At 715, the first WCD 705 may transmit, and the second WCD 710 may receive, a trigger communication. The trigger communication may be similar to the first access procedure communication (e.g., the inventory trigger message) described in connection with FIG. 5 at 515 or the trigger communication described in connection with FIGS. 6 and 615. The trigger communication may be referred to as a message 0, an Msg. 0 communication, an inventory trigger message, or a paging message (e.g., an A-IoT paging message), among other examples. The trigger communication may include information indicative of a set of WCDs (e.g., a set of A-IoT devices) including the second WCD 710. For example, the trigger communication may include a command (e.g., a query) to indicate a specified group of WCDs (e.g., including the second WCD 710) that are to respond (e.g., to establish a communication connection with the first WCD 705). In some examples, the trigger communication may include identifiers of respective WCDs included in the set of WCDs.

The first WCD 705 may transmit the trigger communication to locate or identify WCDs (such as the second WCD 710) that are available in a given area at a given time. For example, the first WCD 705 may be unaware of which or how many WCDs are available or located in a given area at a given time. Therefore, the first WCD 705 may transmit the trigger communication to initiate the access procedure or an inventory procedure (e.g., to enable the first WCD 705 to identify which or how many WCDs are available and to establish a communication connection with one or more of the available WCDs). In some examples, the first WCD 705 may transmit the trigger communication via an R2D channel.

In some aspects, the trigger communication may indicate the set of sequence indices that are available for use by the second WCD 710 (e.g., described above in connection with the configuration information). For example, the first WCD 705 may indicate one or more sequences (e.g., by indicating one or more sequence indices) that can be used by the second WCD 710 in a response (e.g., a sequence communication) to the first WCD 705.

At 720, the second WCD 710 may transmit, and the first WCD 705 may receive, a sequence communication that indicates a first sequence. The sequence communication may be similar to the second access procedure communication described in connection with FIG. 5 at 520. The second WCD 710 may select the first sequence. The second WCD 710 may select the first sequence from the set of sequences (e.g., indicated by the set of sequence indices) indicated by the first WCD 705 as being available for use. In some aspects, the second WCD 710 may randomly select the first sequence from the set of sequences. The first sequence may be associated with a first index (e.g., a first sequence index). The first index may identify the first sequence. The first sequence may be associated with a cyclic shift. For example, the first sequence may be based on a root sequence and the cyclic shift (e.g., the second WCD 710 may generate the first sequence by applying the cyclic shift to the root sequence). The sequence communication may indicate, or include, the first sequence (e.g., that was selected by the second WCD 710). The second WCD 710 may transmit the sequence communication using first one or more time resources (e.g., during a first time instance). The sequence communication may be a first channel communication. For example, the first channel may be a sequence-based channel (e.g., similar to a PRACH). The first channel may be a first D2R channel.

At 725, the first WCD 705 may perform a detection operation in association with, based on, or using the sequence communication. For example, the first WCD 705 may sample one or more time domain samples of the sequence communication to detect a peak location (e.g., a detected peak location). The detected peak location may be one or more time domain samples having a highest received power (e.g., among a set of time domain samples). The location of the detected peak location in the time domain may indicate the sequence indicated by the sequence communication. For example, as different sequences may be cyclic-shifted versions of a root sequence, each sequence may be associated with a respective sequence window in the time domain. If the detected peak location occurs within a given sequence window, then the first WCD 705 may detect that the sequence is a sequence corresponding to the given sequence window. The first WCD 705 may perform the detection operation using one or more PHY layer (or Layer 1) components, such as by measuring or sampling one or more time domain samples of the sequence communication.

As shown in FIG. 7, at 725, the first WCD 705 may detect a second sequence. The second sequence may be different than the first sequence (e.g., that is indicated by the sequence communication at 720). For example, the sequence communication may experience SFO which results in a time domain error or shift in the detected peak location. This may result in a sequence misdetection by the first WCD 705 if the time domain error or shift causes the detected peak location to occur during a sequence window corresponding to a sequence (e.g., the second sequence) that is different that the sequence transmitted via the sequence communication at 720). For example, when the peak of the received signal shifts due to SFO, the detected peak may fall within the time window of an adjacent sequence (e.g., adjacent to the sequence actually transmitted by the second WCD 710 at 720), resulting in the first WCD 705 detecting the adjacent sequence at 725 rather than the sequence actually transmitted by the second WCD 710 at 720.

In some aspects, at 730, the first WCD 705 may detect or identify a misdetection event based on the detected peak of the sequence communication. For example, the first WCD 705 may detect the misdetection event by analyzing the detected peak location in the time domain. If the detected peak is near the boundary of the expected sequence window, the first WCD 705 may detect or identify that a misdetection event has occurred.

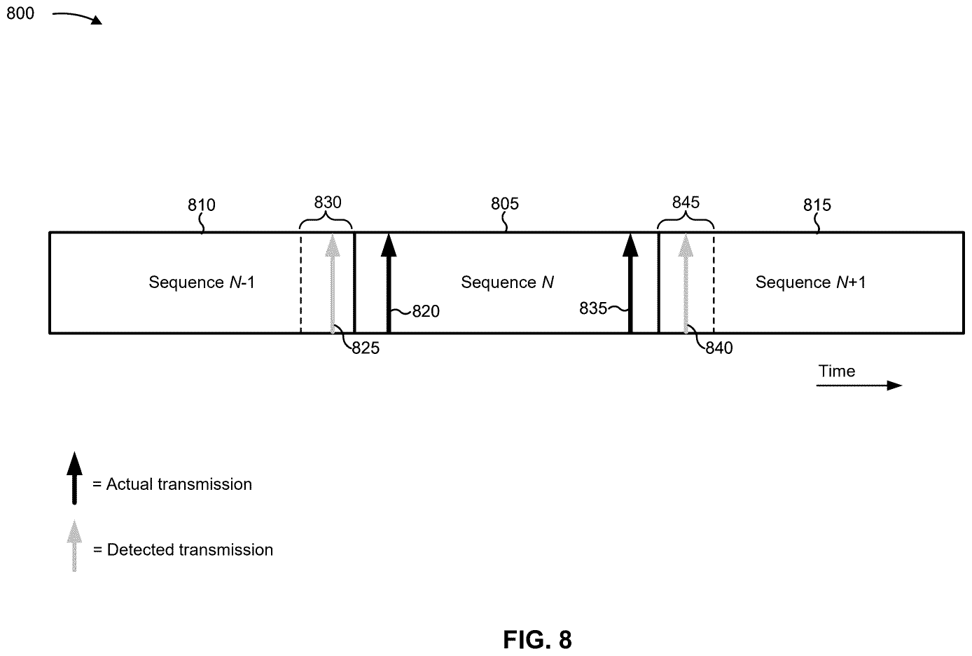

For example, if the detected peak location falls before or after the center of the expected sequence window, then the first WCD 705 may determine that the actual transmitted sequence could be either the current sequence or one of the adjacent sequences. As an example, a sequence window may include one or more time windows. A time window may include one or more time domain samples at the start of a sequence window or at the end of a sequence window. If a detected peak location is within a time window of a sequence window, then the first WCD 705 may detect that the misdetection event has occurred at 730. For example, if the detected peak is near a boundary of a sequence window, there is a higher likelihood of sequence misdetection. The time windows of a sequence window are depicted and described in more detail in connection with FIG. 8.

The first WCD 705 may identify one or more sequences corresponding to the time window in which the detected peak location occurs. As an example, the detected peak location may occur in a time window that is near a boundary between a sequence window for the second sequence and a sequence window for the first sequence. As a result, the first WCD 705 may identify that the time window corresponds to the second sequence and the first sequence.

At 735, the first WCD 705 may transmit an indication of the first sequence and the second sequence. For example, the first WCD 705 may transmit a first communication indicating the second sequence (e.g., that was detected by the first WCD 705 at 725). The first communication may indicate a first resource allocation. Based at least in part on the first WCD 705 detecting the misdetection event at 730, the first WCD 705 may transmit a second communication indicating the first sequence (e.g., that corresponds to a time window in which the detected peak location of the sequence communication occurs). The second communication may include a second resource allocation. By the first WCD 705 transmitting indications of the detected sequence (e.g., the second sequence) and one or more additional sequences, a likelihood of the first WCD 705 transmitting an indication of the sequence that was actually transmitted by the second WCD 710 at 720 may be improved. Additionally, by the first WCD 705 identifying a candidate sequence (e.g., the first sequence) using the time window in which the detected peak location occurs, the first WCD 705 may identify one or more candidate sequences (e.g., in addition to the sequence detected at 725) that have a higher likelihood of being the sequence that was actually transmitted by the second WCD 710 at 720.

The second WCD 710 may receive or detect the second communication that indicates the first index of the first sequence. The second WCD 710 may identify that the second communication is intended for the second WCD 710 based at least in part on the second communication indicating the first sequence. In some aspects, the second WCD 710 may transmit, and the first WCD 705 may receive, a communication (such as the fourth access procedure communication described in connection with FIG. 5 at 530) using the second resource allocation indicated by the second communication. This improves a likelihood that the first WCD 705 and the second WCD 710 are able to successfully complete a procedure, such as an access procedure or an inventory procedure (e.g., because the second WCD 710 receives a resource allocation that is associated with the sequence that was actually transmitted at 720 even though there was a sequence misdetection by the first WCD 705 at 725).

As indicated above, FIG. 7 is provided as an example. Other examples may differ from what is described with respect to FIG. 7.

FIG. 8 is a diagram of an example 800 associated with sequence windows and sequence misdetections. As shown in FIG. 8, sequences may be associated with respective sequence windows in the time domain. For example, a first sequence (e.g., associated with an index N, and shown as sequence N in FIG. 8) may be associated with a sequence window 805. A second sequence (e.g., associated with an index N−1, and shown as sequence N−1 in FIG. 8) may be associated with a sequence window 810. A third sequence (e.g., associated with an index N+1, and shown as sequence N+1 in FIG. 8) may be associated with a sequence window 815.

As an example, if a WCD (such as the first WCD 605 or the first WCD 705) detects a peak location of a sequence communication in the sequence window 805, then the WCD may detect that the sequence communication indicates the first sequence. For example, a transmitting device (e.g., the second WCD 610 or the second WCD 710) may transmit a sequence communication with a first peak location 820 to indicate the first sequence. As an example, the WCD may transmit a sequence communication with a first peak location 820 as described in connection with FIG. 6 at 630 or with FIG. 7 at 720. However, because of timing errors (such as due to SFO or other factors), a receiving device may detect the peak location of the sequence communication at a second peak location 825. As shown in FIG. 8, the time shift between the first peak location 820 and the second peak location 825 may cause the receiving device to detect the second sequence (e.g., the sequence N-1) rather than the first sequence (e.g., the sequence N) that was intended by the transmitting device. For example, the first peak location 820 may occur during the sequence window 805, but due to a positive SFO (and a negative time shift), the second peak location 825 may occur during the sequence window 810.

In some aspects, the receiving device may detect a misdetection event (e.g., in a similar manner as described in connection with FIG. 7 at 730) based at least in part on the second peak location 825 occurring during a time window 830 within the sequence window 810. The time window 830 may include an amount of time (e.g., one or more time samples) from the end of the sequence window 810. The second peak location 825 occurring during the time window 830 may be indicative of a potential sequence misdetection (e.g., because the detected peak location is near a sequence boundary). As a result, the receiving device may transmit communications for both the second sequence (e.g., the sequence N-1) and the first sequence (e.g., the sequence N) (e.g., such as described in connection with FIG. 7 at 735). For example, because the time window 830 occurs at a boundary between the sequence window 810 and the sequence window 805, the receiving device may identify that the time window 830 corresponds to, or is associated with, the first sequence (e.g., the sequence N). By the receiving device transmitting communications for both the second sequence (e.g., the sequence N−1) and the first sequence (e.g., the sequence N), the likelihood of the receiving device transmitting a communication for an actually transmitted sequence may be improved.

As another example, a transmitting device (e.g., the second WCD 610 or the second WCD 710) may transmit a sequence communication with a third peak location 835, as described in connection with FIG. 6 at 630 or with FIG. 7 at 720. However, because of timing errors (such as due to SFO or other factors), a receiving device (e.g., the first WCD 605 or the second WCD 610) may detect the peak location of the sequence communication at a fourth peak location 840. As shown in FIG. 8, the time shift between the third peak location 835 and the fourth peak location 840 may cause the receiving device to detect the third sequence (e.g., the sequence N+1) rather than the first sequence (e.g., the sequence N) that was intended by the transmitting device. For example, the third peak location 835 may occur during the sequence window 805, but due to a negative SFO (and a positive time shift), the fourth peak location 840 may occur during the sequence window 815.

In some aspects, the receiving device may detect a misdetection event (e.g., in a similar manner as described in connection with FIG. 7 at 730) based at least in part on the fourth peak location 840 occurring during a time window 845 within the sequence window 815. The time window 845 may include an amount of time (e.g., one or more time samples) from the start of the sequence window 815. The fourth peak location 840 occurring during the time window 845 may be indicative of a potential sequence misdetection (e.g., because the detected peak location is near a sequence boundary). As a result, the receiving device may transmit communications for both the third sequence (e.g., the sequence N+1) and the first sequence (e.g., the sequence N) (e.g., such as described in connection with FIG. 7 at 735). For example, because the time window 845 occurs at a boundary between the sequence window 815 and the sequence window 805, the receiving device may identify that the time window 845 corresponds to, or is associated with, the first sequence (e.g., the sequence N). By the receiving device transmitting communications for both the third sequence (e.g., the sequence N+1) and the first sequence (e.g., the sequence N), the likelihood of the receiving device transmitting a communication for an actually transmitted sequence may be improved.

As indicated above, FIG. 8 is provided as an example. Other examples may differ from what is described with respect to FIG. 8.

FIG. 9 is a flowchart of an example method 900 of wireless communication. The method 900 may be performed at, for example, a first wireless communication device (e.g., first wireless communication device 605 or the first wireless communication device 705) or an apparatus of a first wireless communication device.

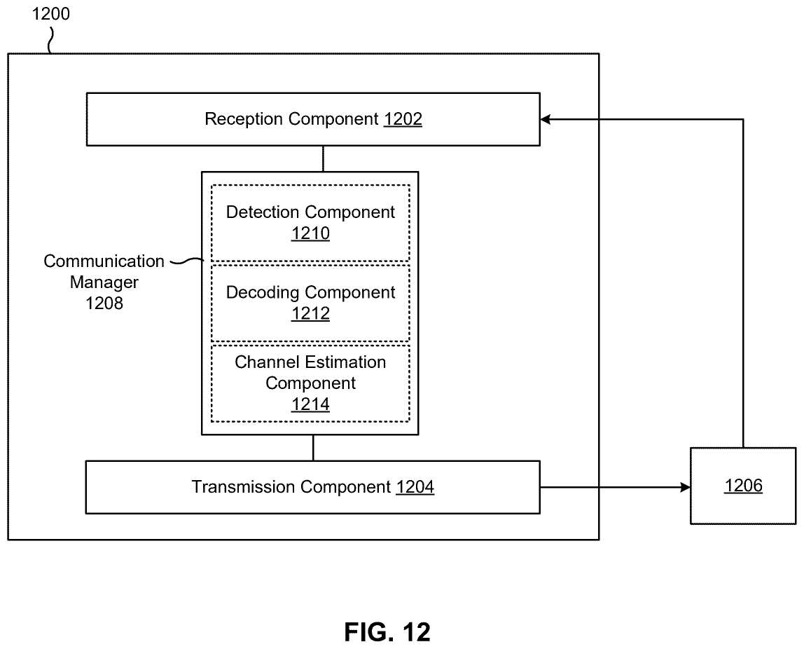

At 910, the first wireless communication device may receive one or more first communications that include a payload communication. For example, the first wireless communication device (e.g., using communication manager 1208 or reception component 1202, depicted in FIG. 12) may receive one or more first communications that include a payload communication, as described above in connection with, for example, FIG. 6 and at 630 or at 635, or FIG. 7 at 720. In some aspects, the one or more first communications and the second communication are associated with at least one of a random access procedure, a feedback procedure, or a cyclic-shift-based communication procedure. In some aspects, the one or more first communications are associated with a detected peak location in a time domain, and the second sequence is associated with the detected peak location.

In some aspects, the first wireless communication device may receive the one or more first communications from a second wireless communication device. In some aspects, the first wireless communication device is a reader, and the second wireless communication device is an A-IoT device.

At 920, the first wireless communication device may detect a first sequence indicated by the one or more first communications. For example, the first wireless communication device (e.g., using communication manager 1208 or detection component 1210, depicted in FIG. 12) may detect a first sequence indicated by the one or more first communications, as described above in connection with, for example, FIG. 6 and at 635 or FIG. 7 at 725. In some aspects, the one or more communications include a sequence communication. The wireless communication device may detect the first sequence in association with the sequence communication.

At 930, the first wireless communication device may perform a decoding operation for the payload communication, the decoding operation indicating a misdetection event associated with the first sequence. For example, the first wireless communication device (e.g., using communication manager 1208 or decoding component 1212, depicted in FIG. 12) may perform a decoding operation for the payload communication, the decoding operation indicating a misdetection event associated with the first sequence, as described above in connection with, for example, FIG. 6 and at 640.

In some aspects, the one or more first communications include a sequence communication indicating the first sequence, wherein performing the decoding operation comprises decoding the payload communication in association with a first index of the first sequence, wherein the misdetection event includes a decoding failure using the first index of the first sequence.

In some aspects, decoding the payload communication comprises performing a first channel estimation operation for the payload communication to obtain one or more first channel estimation values, wherein the decoding failure is a channel estimation failure associated with the one or more first channel estimation values not satisfying a threshold.

In some aspects, decoding the payload communication comprises decoding the payload communication using the first index, wherein the decoding failure is associated with an error decoding the payload communication using the first index. In some aspects, method 900 includes decoding, based at least in part on the decoding failure, the payload communication using a second index of the second sequence, wherein the second communication indicating the second sequence is based at least in part on a decoding success using the second index of the second sequence.

In some aspects, the first sequence is associated with one or more time domain windows, wherein the detected peak location is included in a time domain window, of the one or more time domain windows, corresponding to the second sequence, and wherein the misdetection event includes the detected peak location being included in the time domain window corresponding to the second sequence.

At 940, the first wireless communication device may transmit a second communication that indicates a second sequence based at least in part on the misdetection event, the second sequence being based at least in part on the first sequence, and the second sequence being associated with the payload communication. For example, the first wireless communication device (e.g., using communication manager 1208 or transmission component 1204, depicted in FIG. 12) may transmit a second communication that indicates a second sequence based at least in part on the misdetection event, the second sequence being based at least in part on the first sequence, and the second sequence being associated with the payload communication, as described above in connection with, for example, FIG. 6 and at 655 or FIG. 7 at 735. In some aspects, the second communication indicates the first sequence and the second sequence based at least in part on the misdetection event. In some aspects, the second sequence is based at least in part on an order of sequence indices. In some aspects, the second sequence is adjacent to the first sequence in the order of sequence indices.

In some aspects, method 900 includes performing, based at least in part on the one or more first channel estimation values not satisfying the threshold, a second channel estimation operation for the payload communication to obtain one or more second channel estimation values, wherein the second channel estimation operation uses a second index of the second sequence, and decoding, based at least in part on the one or more second channel estimation values satisfying the threshold, the payload communication using the one or more second channel estimation values, wherein the second communication indicating the second sequence is based at least in part on a decoding success using the one or more second channel estimation values.

In some aspects, method 900 includes transmitting an indication of a set of sequence indices, wherein the set of sequence indices include a first index associated with the first sequence and a second index associated with the second sequence, wherein the indication of the set of sequence indices indicates that the second wireless communication device is to use an index, from the set of sequence indices, as an input for generation of a portion of the one or more first communications, wherein the portion includes at least one of a demodulation reference signal or data.

In some aspects, the second communication includes a first resource allocation associated with the first sequence based at least in part on detecting the first sequence, and the second communication includes a second resource allocation associated with the second sequence based at least in part on the misdetection event.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a flowchart of an example method 1000 of wireless communication. The method 1000 may be performed at, for example, a first wireless communication device (e.g., the second wireless communication device 610 or the second wireless communication device 710) or an apparatus of a first wireless communication device.

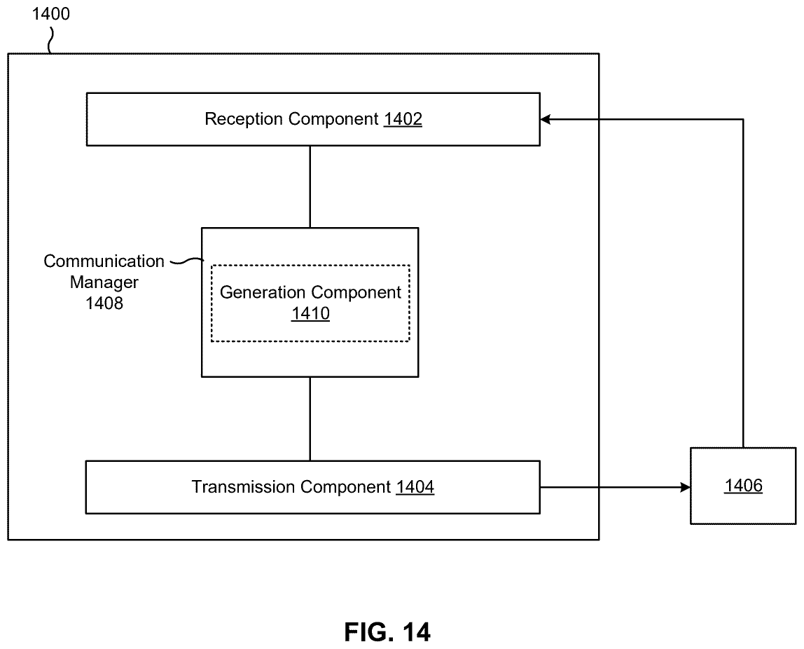

At 1010, the first wireless communication device may receive an indication of one or more sequence indices associated with one or more sequences. For example, the first wireless communication device (e.g., using communication manager 1408 or reception component 1402, depicted in FIG. 14) may receive an indication of one or more sequence indices associated with one or more sequences, as described above in connection with, for example, FIG. 6 and at 615. In some aspects, the first wireless communication device is an A-IoT device.

In some aspects, receiving the indication of the one or more sequence indices comprises receiving an indication that the index is to be associated with one or more portions of the second communication (e.g., described below).

At 1020, the first wireless communication device may transmit a first communication that indicates a sequence from the one or more sequences. For example, the first wireless communication device (e.g., using communication manager 1408 or transmission component 1404, depicted in FIG. 14) may transmit a first communication that indicates a sequence from the one or more sequences, as described above in connection with, for example, FIG. 6 and at 630. In some aspects, the first communication is a sequence communication for an initial communication of a random access procedure.

At 1030, the first wireless communication device may transmit a second communication that includes one or more portions that are based at least in part on an index of the sequence from the one or more sequence indices. For example, the first wireless communication device (e.g., using communication manager 1408 or transmission component 1404, depicted in FIG. 14) may transmit a second communication that includes one or more portions that are based at least in part on an index of the sequence from the one or more sequence indices, as described above in connection with, for example, FIG. 6 and at 635. In some aspects, the one or more portions include data. In some aspects, the one or more portions are scrambled using the index of the sequence. In some aspects, the one or more portions include a channel estimate signal. In some aspects, the channel estimate signal is a demodulation reference signal. In some aspects, the second communication is a payload communication for the initial communication.

In some aspects, method 1000 includes generating the one or more portions using the index of the sequence as an input.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a flowchart of an example method 1100 of wireless communication. The method 1100 may be performed at, for example, a first wireless communication device (e.g., the first wireless communication device 605 or the first wireless communication device 705) or an apparatus of a first wireless communication device.

At 1110, the first wireless communication device may receive a first communication. For example, the first wireless communication device (e.g., using communication manager 1208 or reception component 1202, depicted in FIG. 12) may receive a first communication, as described above in connection with, for example, FIG. 7 and at 720. In some aspects, the first wireless communication device may receive the first communication from a second wireless communication device. In some aspects, the first wireless communication device is a reader, and the second wireless communication device is an A-IoT device.

At 1120, the first wireless communication device may detect a first sequence indicated by the first communication, the first sequence being based at least in part on a detected peak location of the first communication in a time domain, and the detected peak location indicating a misdetection event associated with the first sequence. For example, the first wireless communication device (e.g., using communication manager 1208 or detection component 1210, depicted in FIG. 12) may detect a first sequence indicated by the first communication, the first sequence being based at least in part on a detected peak location of the first communication in a time domain, and the detected peak location indicating a misdetection event associated with the first sequence, as described above in connection with, for example, FIG. 7 and at 725.

In some aspects, the first sequence is associated with one or more time domain windows, wherein the detected peak location is included in a time domain window, of the one or more time domain windows, corresponding to a second sequence, and wherein the misdetection event includes the detected peak location being included in the time domain window corresponding to the second sequence.

At 1130, the first wireless communication device may transmit a second communication that indicates a second sequence based at least in part on the misdetection event. For example, the first wireless communication device (e.g., using communication manager 1208 or transmission component 1204, depicted in FIG. 12) may transmit a second communication that indicates a second sequence based at least in part on the misdetection event, as described above in connection with, for example, FIG. 7 and at 735. In some aspects, the second sequence is adjacent to the first sequence in an order of sequence indices. In some aspects, the second sequence is associated with the detected peak location.

In some aspects, the second communication indicates the first sequence and the second sequence based at least in part on the misdetection event. In some aspects, the second communication includes a first resource allocation associated with the first sequence based at least in part on detecting the first sequence, and the second communication includes a second resource allocation associated with the second sequence based at least in part on the misdetection event.

In some aspects, the first communication and the second communication are associated with at least one of a random access procedure, a feedback procedure, or a cyclic-shift-based communication procedure.

Although FIG. 11 shows example blocks of method 1100, in some aspects, method 1100 may include additional blocks, fewer blocks, different blocks, or differently arranged blocks than those depicted in FIG. 11. Additionally, or alternatively, two or more of the blocks of method 1100 may be performed in parallel.

FIG. 12 is a diagram of an example apparatus 1200 for wireless communication. The apparatus 1200 may be a wireless communication device, or a wireless communication device may include the apparatus 1200. In some aspects, the wireless communication device may be a reader device, a UE, or a network node. In some aspects, the apparatus 1200 includes a reception component 1202 and a transmission component 1204, which may be in communication with one another (for example, via one or more buses or one or more other components). As shown, the apparatus 1200 may communicate with another apparatus 1206 (such as a UE, a base station, an A-IoT device, or another wireless communication device) using the reception component 1202 and the transmission component 1204. As further shown, the apparatus 1200 may include the communication manager 1208 (e.g., the communication manager 150 or the communication manager 155). The communication manager 1208 may include one or more of a detection component 1210, a decoding component 1212, or a channel estimation component 1214, among other examples. The communication manager 1208 may be included in, or implemented via, a processing system (for example, the processing system 140 or the processing system 145 described in connection with FIG. 1).

In some aspects, the apparatus 1200 may be configured to perform one or more operations described herein in connection with FIGS. 6-8. Additionally, or alternatively, the apparatus 1200 may be configured to perform one or more processes described herein, such as method 900 of FIG. 9, method 1100 of FIG. 11, or a combination thereof. In some aspects, the apparatus 1200 or one or more components shown in FIG. 12 may include one or more components described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components described above in connection with FIG. 1, such as a radio, one or more RF chains, one or more transceivers, or one or more modems, each of which may in turn be coupled with one or more antennas.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more components described above in connection with FIG. 1, such as a radio, one or more RF chains, one or more transceivers, or one or more modems, each of which may in turn be coupled with one or more antennas described in connection with FIG. 1. In some aspects, the transmission component 1204 may be co-located with the reception component 1202.

The reception component 1202 may receive one or more first communications that include a payload communication. The detection component 1210 may detect a first sequence indicated by the one or more first communications. The decoding component 1212 may perform a decoding operation for the payload communication, the decoding operation indicating a misdetection event associated with the first sequence. The transmission component 1204 may transmit a second communication that indicates a second sequence based at least in part on the misdetection event, the second sequence being based at least in part on the first sequence, and the second sequence being associated with the payload communication.

The channel estimation component 1214 may perform, based at least in part on the one or more first channel estimation values not satisfying the threshold, a second channel estimation operation for the payload communication to obtain one or more second channel estimation values, wherein the second channel estimation operation uses a second index of the second sequence. The channel estimation component 1214 may decode, based at least in part on the one or more second channel estimation values satisfying the threshold, the payload communication using the one or more second channel estimation values, wherein the second communication indicating the second sequence is based at least in part on a decoding success using the one or more second channel estimation values.

The decoding component 1212 may decode, based at least in part on the decoding failure, the payload communication using a second index of the second sequence, wherein the second communication indicating the second sequence is based at least in part on a decoding success using the second index of the second sequence.

The transmission component 1204 may transmit an indication of a set of sequence indices, wherein the set of sequence indices include a first index associated with the first sequence and a second index associated with the second sequence, wherein the indication of the set of sequence indices indicates that the second wireless communication device is to use an index, from the set of sequence indices, as an input for generation of a portion of the one or more first communications, wherein the portion includes at least one of a demodulation reference signal or data.

The reception component 1202 may receive a first communication. The detection component 1210 may detect a first sequence indicated by the first communication, the first sequence being based at least in part on a detected peak location of the first communication in a time domain, and the detected peak location indicating a misdetection event associated with the first sequence. The transmission component 1204 may transmit a second communication that indicates a second sequence based at least in part on the misdetection event.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

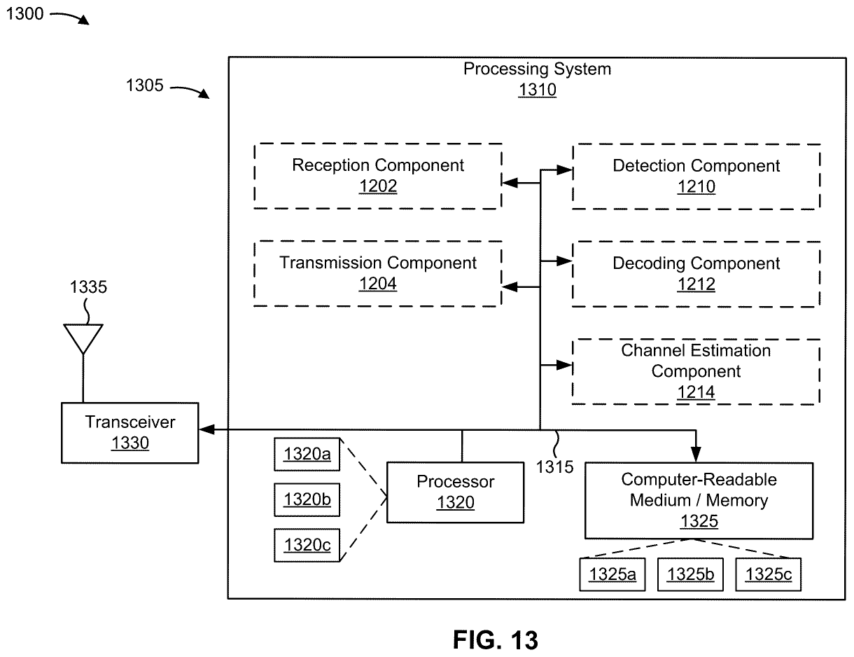

FIG. 13 is a diagram illustrating an example 1300 of a hardware implementation for an apparatus 1305 employing a processing system 1310. The apparatus 1305 may be a wireless communication device or may be at (e.g., included in) a wireless communication device. The processing system 1310 may be, or may be similar to, the processing system 140 of the UE 120 or the processing system 145 of the network node 110 described in connection with FIG. 1).

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors or hardware components, represented by the processor (or processing circuitry) 1320, the illustrated components, and the computer-readable medium/memory (or memory circuitry) 1325. The processor 1320 may include multiple processors, such as processor 1320a, processor 1320b, and processor 1320c. The memory 1325 may include multiple memories, such as memory 1325a, memory 1325b, and memory 1325c. The bus 1315 may also link various other circuits, such as timing sources, peripherals, voltage regulators, or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium/memory 1325. A processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 or may be, may include, or may be included in the processing system 140 of the UE 120 described in connection with FIG. 1. In other aspects, the processing system 1310 may be a component of the network node 110 or may be, may include, or may be included in the processing system 145 of the network node 110 described in connection with FIG. 1. In some aspects, the processing system 1310 may be a component of the reader device 175. In some aspects, the apparatus 1305 for wireless communication includes means for receiving, from a second wireless communication device, one or more first communications that include a payload communication; means for detecting a first sequence indicated by the one or more first communications; means for performing a decoding operation for the payload communication, the decoding operation indicating a misdetection event associated with the first sequence; or means for transmitting a second communication that indicates a second sequence based at least in part on the misdetection event, the second sequence being based at least in part on the first sequence, and the second sequence being associated with the payload communication. Additionally, or alternatively, the apparatus 1305 for wireless communication includes means for receiving, from a second wireless communication device, a first communication; means for detecting a first sequence indicated by the first communication, the first sequence being based at least in part on a detected peak location of the first communication in a time domain, and the detected peak location indicating a misdetection event associated with the first sequence; or means for transmitting a second communication that indicates a second sequence based at least in part on the misdetection event. The aforementioned means may be one or more of the aforementioned components of the apparatus 1200 or the processing system 1310 of the apparatus 1305 configured to perform the functions recited by the aforementioned means. As described elsewhere herein, the processing system 1310 may include one or more components of the processing system 140 of the UE 120 or the processing system 145 of the network node 110 described in connection with FIG. 1. In one configuration, the aforementioned means may be the processing system 140 or one or more components of the processing system 140 configured to perform the functions or operations recited herein. In another configuration, the aforementioned means may be the processing system 145 or one or more components of the processing system 145 configured to perform the functions or operations recited herein.

FIG. 13 is provided as an example. Other examples may differ from what is described in connection with FIG. 13.

FIG. 14 is a diagram of an example apparatus 1400 for wireless communication. The apparatus 1400 may be a wireless communication device, or a wireless communication device may include the apparatus 1400. In some aspects, the wireless communication device may be a UE or an A-IoT device. In some aspects, the apparatus 1400 includes a reception component 1402 and a transmission component 1404, which may be in communication with one another (for example, via one or more buses or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 1408. The communication manager 1408 may be similar to the communication manager 150. The communication manager 1408 may include a generation component 1410, among other examples. The communication manager 1408 may be included in, or implemented via, a processing system (for example, the processing system 140 described in connection with FIG. 1).

In some aspects, the apparatus 1400 may be configured to perform one or more operations described herein in connection with FIGS. 6-8. Additionally, or alternatively, the apparatus 1400 may be configured to perform one or more processes described herein, such as method 1000 of FIG. 10, or a combination thereof. In some aspects, the apparatus 1400 or one or more components shown in FIG. 14 may include one or more components described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components described above in connection with FIG. 1, such as a radio, one or more RF chains, one or more transceivers, or one or more modems, each of which may in turn be coupled with one or more antennas.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more components described above in connection with FIG. 1, such as a radio, one or more RF chains, one or more transceivers, or one or more modems, each of which may in turn be coupled with one or more antennas described in connection with FIG. 1. In some aspects, the transmission component 1404 may be co-located with the reception component 1402.

The reception component 1402 may receive an indication of one or more sequence indices associated with one or more sequences. The transmission component 1404 may transmit a first communication that indicates a sequence from the one or more sequences. The transmission component 1404 may transmit a second communication that includes one or more portions that are based at least in part on an index of the sequence from the one or more sequence indices.

The generation component 1410 may generate the one or more portions using the index of the sequence as an input. In some aspects, the generation component 1410 may scramble the one or more portions using the index of the sequence.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

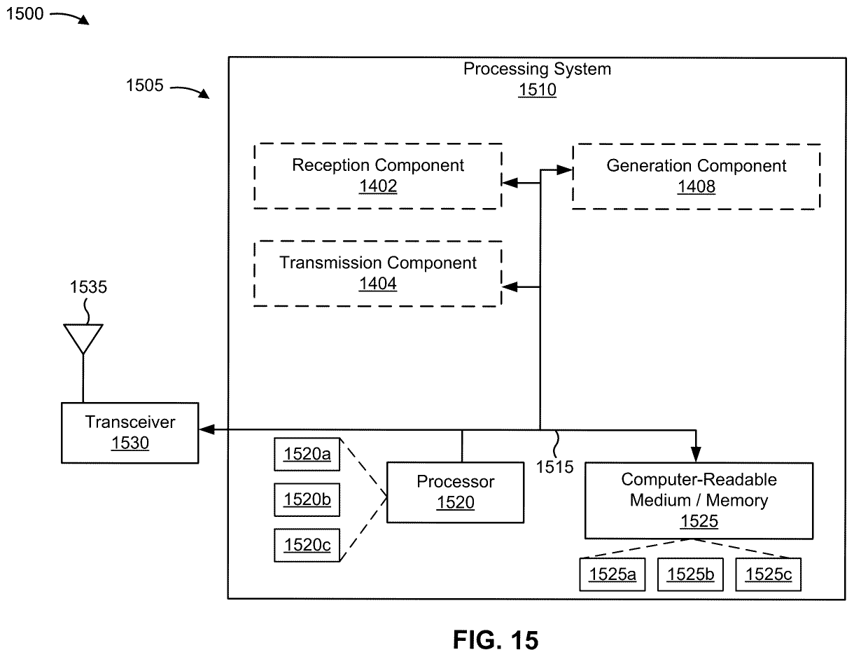

FIG. 15 is a diagram illustrating an example 1500 of a hardware implementation for an apparatus 1505 employing a processing system 1510. The apparatus 1505 may be a wireless communication device or may be at (e.g., included in) a wireless communication device. The processing system 1510 may be, or may be similar to, the processing system 140 of the UE 120 or a processing system of the A-IoT device 170 described in connection with FIG. 1).

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors or hardware components, represented by the processor (or processing circuitry) 1520, the illustrated components, and the computer-readable medium/memory (or memory circuitry) 1525. The processor 1520 may include multiple processors, such as processor 1520a, processor 1520b, and processor 1520c. The memory 1525 may include multiple memories, such as memory 1525a, memory 1525b, and memory 1525c. The bus 1515 may also link various other circuits, such as timing sources, peripherals, voltage regulators, or power management circuits.

The processing system 1510 may be coupled to one or more transceivers 1530. A transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes one or more processors 1520 coupled to a computer-readable medium/memory 1525. A processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be a component of the UE 120 or may be, may include, or may be included in the processing system 140 of the UE 120 described in connection with FIG. 1. In some aspects, the processing system 1510 may be a component of the A-IoT device 170 or may be, may include, or may be included in processing system of the A-IoT device 170 described in connection with FIG. 1. In some aspects, the apparatus 1505 for wireless communication includes means for receiving an indication of one or more sequence indices associated with one or more sequences; means for transmitting a first communication that indicates a sequence from the one or more sequences; or means for transmitting a second communication that includes one or more portions that are based at least in part on an index of the sequence from the one or more sequence indices. In some aspects, the apparatus 1505 for wireless communication includes means for generating the one or more portions using the index of the sequence as an input. The aforementioned means may be one or more of the aforementioned components of the apparatus 1400 or the processing system 1510 of the apparatus 1505 configured to perform the functions recited by the aforementioned means. As described elsewhere herein, the processing system 1510 may include one or more components of the processing system 140 of the UE 120 described in connection with FIG. 1. In some aspects, the processing system 1510 may include one or more components of the processing system of the A-IoT device 170. In one configuration, the aforementioned means may be the processing system 140 or one or more components of the processing system 140 configured to perform the functions or operations recited herein.

FIG. 15 is provided as an example. Other examples may differ from what is described in connection with FIG. 15.

The following provides an overview of some Aspects of the present disclosure:

Aspect 1: A method of wireless communication performed by a first wireless communication device, comprising: receiving, from a second wireless communication device, one or more first communications that include a payload communication; detecting a first sequence indicated by the one or more first communications; performing a decoding operation for the payload communication, the decoding operation indicating a misdetection event associated with the first sequence; and transmitting a second communication that indicates a second sequence based at least in part on the misdetection event, the second sequence being based at least in part on the first sequence, and the second sequence being associated with the payload communication.

Aspect 2: The method of Aspect 1, wherein the one or more first communications include a sequence communication indicating the first sequence, wherein performing the decoding operation comprises: decoding the payload communication in association with a first index of the first sequence, wherein the misdetection event includes a decoding failure using the first index of the first sequence.

Aspect 3: The method of Aspect 2, wherein decoding the payload communication comprises: performing, using the first index, a first channel estimation operation for the payload communication to obtain one or more first channel estimation values, wherein the decoding failure is a channel estimation failure associated with the one or more first channel estimation values not satisfying a threshold.

Aspect 4: The method of Aspect 3, further comprising: performing, based at least in part on the one or more first channel estimation values not satisfying the threshold, a second channel estimation operation for the payload communication to obtain one or more second channel estimation values, wherein the second channel estimation operation uses a second index of the second sequence; and decoding, based at least in part on the one or more second channel estimation values satisfying the threshold, the payload communication using the one or more second channel estimation values, wherein the second communication indicating the second sequence is based at least in part on a decoding success using the one or more second channel estimation values.

Aspect 5: The method of any of Aspects 2-4, wherein decoding the payload communication comprises: decoding the payload communication using the first index, wherein the decoding failure is associated with an error decoding the payload communication using the first index.

Aspect 6: The method of Aspect 5, further comprising: decoding, based at least in part on the decoding failure, the payload communication using a second index of the second sequence, wherein the second communication indicating the second sequence is based at least in part on a decoding success using the second index of the second sequence.

Aspect 7: The method of any of Aspects 1-6, further comprising: transmitting an indication of a set of sequence indices, wherein the set of sequence indices include a first index associated with the first sequence and a second index associated with the second sequence, wherein the indication of the set of sequence indices indicates that the second wireless communication device is to use an index, from the set of sequence indices, as an input for generation of a portion of the one or more first communications, wherein the portion includes at least one of a demodulation reference signal or data.

Aspect 8: The method of any of Aspects 1-7, wherein the second sequence is based at least in part on an order of sequence indices.

Aspect 9: The method of Aspect 8, wherein the second sequence is adjacent to the first sequence in the order of sequence indices.

Aspect 10: The method of any of Aspects 1-9, wherein the one or more first communications are associated with a detected peak location in a time domain, and wherein the second sequence is associated with the detected peak location.

Aspect 11: The method of Aspect 10, wherein the first sequence is associated with one or more time domain windows, wherein the detected peak location is included in a time domain window, of the one or more time domain windows, corresponding to the second sequence, and wherein the misdetection event includes the detected peak location being included in the time domain window corresponding to the second sequence.

Aspect 12: The method of any of Aspects 1-11, wherein the second communication indicates the first sequence and the second sequence based at least in part on the misdetection event.

Aspect 13: The method of any of Aspects 1-12, wherein the second communication includes a first resource allocation associated with the first sequence based at least in part on detecting the first sequence, and wherein the second communication includes a second resource allocation associated with the second sequence based at least in part on the misdetection event.

Aspect 14: The method of any of Aspects 1-13, wherein the first wireless communication device is a reader, and wherein the second wireless communication device is an ambient Internet-of-things (A-IoT) device.

Aspect 15: The method of any of Aspects 1-14, wherein the one or more first communications and the second communication are associated with at least one of a random access procedure, a feedback procedure, or a cyclic-shift-based communication procedure.

Aspect 16: A method of wireless communication performed by a first wireless communication device, comprising: receiving an indication of one or more sequence indices associated with one or more sequences; transmitting a first communication that indicates a sequence from the one or more sequences; and transmitting a second communication that includes one or more portions that are based at least in part on an index of the sequence from the one or more sequence indices.

Aspect 17: The method of Aspect 16, wherein the one or more portions include a channel estimate signal.

Aspect 18: The method of Aspect 17, wherein the channel estimate signal is a demodulation reference signal.

Aspect 19: The method of any of Aspects 16-18, wherein the one or more portions include data.

Aspect 20: The method of any of Aspects 16-19, wherein the one or more portions are scrambled using the index of the sequence.

Aspect 21: The method of any of Aspects 16-20, further comprising: generating the one or more portions using the index of the sequence as an input.

Aspect 22: The method of any of Aspects 16-21, wherein receiving the indication of the one or more sequence indices comprises: receiving an indication that the index is to be associated with the one or more portions.

Aspect 23: The method of any of Aspects 16-22, wherein the first communication is a sequence communication for an initial communication of a random access procedure, and wherein the second communication is a payload communication for the initial communication.

Aspect 24: The method of any of Aspects 16-23, wherein the first wireless communication device is an ambient Internet-of-things (A-IoT) device.

Aspect 25: A method of wireless communication performed by a first wireless communication device, comprising: receiving, from a second wireless communication device, a first communication; detecting a first sequence indicated by the first communication, the first sequence being based at least in part on a detected peak location of the first communication in a time domain, and the detected peak location indicating a misdetection event associated with the first sequence; and transmitting a second communication that indicates a second sequence based at least in part on the misdetection event.

Aspect 26: The method of Aspect 25, wherein the second sequence is adjacent to the first sequence in an order of sequence indices.

Aspect 27: The method of any of Aspects 25-26, wherein the second sequence is associated with the detected peak location.

Aspect 28: The method of any of Aspects 25-27, wherein the first sequence is associated with one or more time domain windows, wherein the detected peak location is included in a time domain window, of the one or more time domain windows, corresponding to the second sequence, and wherein the misdetection event includes the detected peak location being included in the time domain window corresponding to the second sequence.

Aspect 29: The method of any of Aspects 25-28, wherein the second communication indicates the first sequence and the second sequence based at least in part on the misdetection event.

Aspect 30: The method of any of Aspects 25-29, wherein the second communication includes a first resource allocation associated with the first sequence based at least in part on detecting the first sequence, and wherein the second communication includes a second resource allocation associated with the second sequence based at least in part on the misdetection event.

Aspect 31: The method of any of Aspects 25-30, wherein the first wireless communication device is a reader, and wherein the second wireless communication device is an ambient Internet-of-things (A-IoT) device.

Aspect 32: The method of any of Aspects 25-31, wherein the first communication and the second communication are associated with at least one of a random access procedure, a feedback procedure, or a cyclic-shift-based communication procedure.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

Aspect 40: A device comprising a processing system that includes one or more processors and one or more code-storing memories coupled with the one or more processors, the processing system configured to cause the device to perform the method of one or more of Aspects 1-32.

Aspect 41: A device comprising a processing system that includes processor circuitry and code-storing memory circuitry, the processing system configured to cause the device to perform the method of one or more of Aspects 1-32.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first wireless communication device, comprising:
one or more memories; and
one or more processors coupled to the one or more memories, the one or more processors individually or collectively configured to:
receive, from a second wireless communication device, one or more first communications that include a payload communication;
detect a first sequence indicated by the one or more first communications;
perform a decoding operation for the payload communication, the decoding operation indicating a misdetection event associated with the first sequence; and
transmit a second communication that indicates a second sequence based at least in part on the misdetection event, the second sequence being based at least in part on the first sequence, and the second sequence being associated with the payload communication.

2. The apparatus of claim 1, wherein the one or more first communications include a sequence communication indicating the first sequence, wherein the one or more processors, to perform the decoding operation, are individually or collectively configured to:
decode the payload communication in association with a first index of the first sequence, wherein the misdetection event includes a decoding failure using the first index of the first sequence.

3. The apparatus of claim 2, wherein the one or more processors, to decode the payload communication, are individually or collectively configured to:
perform, using the first index, a first channel estimation operation for the payload communication to obtain one or more first channel estimation values, wherein the decoding failure is a channel estimation failure associated with the one or more first channel estimation values not satisfying a threshold.

4. The apparatus of claim 3, wherein the one or more processors are individually or collectively configured to:
perform, based at least in part on the one or more first channel estimation values not satisfying the threshold, a second channel estimation operation for the payload communication to obtain one or more second channel estimation values, wherein the second channel estimation operation uses a second index of the second sequence; and
decode, based at least in part on the one or more second channel estimation values satisfying the threshold, the payload communication using the one or more second channel estimation values, wherein the second communication indicating the second sequence is based at least in part on a decoding success using the one or more second channel estimation values.

5. The apparatus of claim 2, wherein the one or more processors, to decode the payload communication, are individually or collectively configured to:
decode the payload communication using the first index, wherein the decoding failure is associated with an error decoding the payload communication using the first index.

6. The apparatus of claim 5, wherein the one or more processors are individually or collectively configured to:
decode, based at least in part on the decoding failure, the payload communication using a second index of the second sequence, wherein the second communication indicating the second sequence is based at least in part on a decoding success using the second index of the second sequence.

7. The apparatus of claim 1, wherein the one or more processors are individually or collectively configured to:
transmit an indication of a set of sequence indices, wherein the set of sequence indices include a first index associated with the first sequence and a second index associated with the second sequence, wherein the indication of the set of sequence indices indicates that the second wireless communication device is to use an index, from the set of sequence indices, as an input for generation of a portion of the one or more first communications, wherein the portion includes at least one of a demodulation reference signal or data.

8. The apparatus of claim 1, wherein the second sequence is based at least in part on an order of sequence indices.

9. The apparatus of claim 8, wherein the second sequence is adjacent to the first sequence in the order of sequence indices.

10. The apparatus of claim 1, wherein the one or more first communications are associated with a detected peak location in a time domain, and wherein the second sequence is associated with the detected peak location.

11. The apparatus of claim 10, wherein the first sequence is associated with one or more time domain windows, wherein the detected peak location is included in a time domain window, of the one or more time domain windows, corresponding to the second sequence, and wherein the misdetection event includes the detected peak location being included in the time domain window corresponding to the second sequence.

12. The apparatus of claim 1, wherein the second communication indicates the first sequence and the second sequence based at least in part on the misdetection event.

13. The apparatus of claim 1, wherein the second communication includes a first resource allocation associated with the first sequence based at least in part on detection of the first sequence, and
wherein the second communication includes a second resource allocation associated with the second sequence based at least in part on the misdetection event.

14. An apparatus for wireless communication at a first wireless communication device, comprising:
one or more memories; and
one or more processors coupled to the one or more memories, the one or more processors individually or collectively configured to:
receive an indication of one or more sequence indices associated with one or more sequences;
transmit a first communication that indicates a sequence from the one or more sequences; and
transmit a second communication that includes one or more portions that are based at least in part on an index of the sequence from the one or more sequence indices.

15. The apparatus of claim 14, wherein the one or more portions include a channel estimate signal.

16. The apparatus of claim 15, wherein the channel estimate signal is a demodulation reference signal.

17. The apparatus of claim 14, wherein the one or more portions include data.

18. The apparatus of claim 14, wherein the one or more processors are individually or collectively configured to:
generate the one or more portions using the index of the sequence as an input.

19. The apparatus of claim 14, wherein the one or more processors, to receive the indication of the one or more sequence indices, are individually or collectively configured to:
receive an indication that the index is to be associated with the one or more portions.

20. An apparatus for wireless communication at a first wireless communication device, comprising:
one or more memories; and
one or more processors coupled to the one or more memories, the one or more processors individually or collectively configured to:
receive, from a second wireless communication device, a first communication;
detect a first sequence indicated by the first communication, the first sequence being based at least in part on a detected peak location of the first communication in a time domain, and the detected peak location indicating a misdetection event associated with the first sequence; and
transmit a second communication that indicates a second sequence based at least in part on the misdetection event.
